(19) United States
(12) Patent Application Publication
(10) Pub. No.: US 2014/0184550 A1
(43) Pub. Date: Jul. 3, 2014

(54) System and Method for Using Eye Gaze Information to Enhance Interactions

(71) Applicant: TandemLaunch Technologies Inc., Westmount (CA)

(72) Inventors: Craig A. HENNESSEY, Vancouver (CA); Jacob FISET, Montreal (CA); Simon ST-HILAIRE, Dollard-Des-Ormeaux (CA)

(73) Assignee: TandemLaunch Technologies Inc., Westmount (CA)

(21) Appl. No.: 14/200,791

(22) Filed: Mar. 7, 2014

Related U.S. Application Data
(63) Continuation of application No. PCT/CA2012/050613, filed on Sep. 5, 2012.
(60) Provisional application No. 61/531,940, filed on Sep. 7, 2011.

(51) Int. Cl. G06F 3/01; G06F 3/041

(52) U.S. Cl. CPC G06F 3/013; G06F 3/041
USPC 345/173; 345/156

(57) ABSTRACT

A system and method are provided for enhancing inputs or interactions. The method comprises correlating gaze information for a subject to information corresponding to an environment; and providing an enhancement to an input or interaction between the subject and the environment. A system and method are also provided for enabling enhanced inputs or interactions with objects in an environment. The method comprises correlating gaze information for a subject to a registration input corresponding to an object in the environment; and registering a position of the object in the environment using the gaze information.

### CROSS-REFERENCE TO RELATED APPLICATIONS

This application is a continuation of PCT Application No. PCT/CA2012/050613 filed on Sep. 5, 2013, which claims priority from U.S. Provisional Patent Application No. 61/531,940 filed on Sep. 7, 2011, the entire contents of which are incorporated herein by reference.

### TECHNICAL FIELD

The following relates to systems and methods for using eye gaze information to enhance interactions.

### DESCRIPTION OF THE RELATED ART

To date, human computer interaction has largely been accomplished using a standard keyboard and mouse. However, recently there has been a shift in interaction style towards more natural interfaces based on human interaction techniques such as voice, touch, and gestures.

Individually, each new interface technique further increases the naturalness of human machine interaction. However the new interface techniques typically lack knowledge of the users intention and so can only work off explicit user commands regardless of the situation context.

It is an object of the following to address the above noted disadvantages.

### SUMMARY

It has been realized that knowing where a viewer is looking can provide behavioral insight into the viewer's cognitive processes, since where the viewer is looking is often closely tied to what the user is thinking. Coupling eye gaze information with existing interfaces allows the ability to infer intention, or context, which can improve the realism and naturalness of the interaction.

In one aspect, there is provided a method of enhancing inputs or interactions, the method comprising: correlating gaze information for a subject to information corresponding to an environment; and providing an enhancement to an input or interaction between the subject and the environment.

In another aspect, there is provided a method of enabling enhanced inputs or interactions with objects in an environment, the method comprising: correlating gaze information for a subject to a registration input corresponding to an object in the environment; and registering a position of the object in the environment using the gaze information.

In yet another aspect, there is provided a computer readable storage medium comprising computer executable instructions for performing the above methods.

In yet another aspect, there is provided an electronic device comprising a processor and memory, the memory comprising computer executable instructions for causing the processor to perform the above methods.

In yet another aspect, there is provided a tracking system comprising the above electronic device.

### BRIEF DESCRIPTION OF THE DRAWINGS

Embodiments will now be described by way of example only with reference to the appended drawings wherein:

FIG. 1 is a block diagram showing an example of an environment including a subject viewing or interacting with an object or system and a tracking system for enhancing interactions within the environment.

FIG. 2 is a block diagram illustrating further detail of the example tracking system shown in FIG. 1.

FIG. 3 is a block diagram of an example configuration for the gaze tracking module of FIG. 2.

FIG. 4 is a schematic illustration of an eye observing an object in the real-world.

FIG. 5 is a schematic illustration of an eye observing an object on a 2-D screen.

FIG. 6 is a plot of point-of-gaze estimates on a 2-D display, showing raw data and fixation filtered data.

FIG. 7 is a block diagram of an example configuration for the input/interaction tracking module of FIG. 2.

FIG. 8 is a block diagram of an example configuration for the environment tracking module of FIG. 2.

FIG. 9 is an image of a real-world environment with various objects in the environment identified.

FIG. 10 is a schematic illustration of a bounding box surrounding a 3D object.

FIG. 11 is a block diagram of an example configuration for the context module of FIG. 2.

FIG. 12 is a flow diagram illustrating an example set of computer executable operations that may be performed in enhancing an input or interaction using gaze information.

FIG. 13 is a flow diagram illustrating an example set of computer executable operations that may be performed in registering an object in an environment using gaze information.

FIG. 14 is a screen shot of an example user interface (UI) including various input mechanisms.

FIG. 15 is a screen shot of an example UI including a slider input mechanism.

FIG. 16 is a schematic illustration of a video game screen including multiple potential targets and the use of gaze information to enhance a gesture for interacting with the potential targets.

FIG. 17 is a screen shot of an example video game UI including multiple objects that can be interacted with.

FIG. 18 is a screen shot of an example UI including various input mechanisms.

FIG. 19 is a schematic illustration of a real world environment including a light switch that can be controlled using gaze information.

FIG. 20 is an example display including multiple input boxes.

FIG. 21 is an example display including multiple input boxes.

FIG. 22 is an example of a touchscreen device providing a remote input key for making a selection on the touchscreen according to gaze information.

FIG. 23 is an example of a computer screen including multiple video conference screen, wherein sound properties are adjusted according to gaze information.

FIG. 24 is an example screen shot of a spreadsheet being viewed by a pair of subjects with gaze information displayed to facilitate collaboration.

FIG. 25 is an example screen shot of a software programming interface being viewed by a pair of subjects with gaze information displayed to facilitate collaboration.

FIG. 26 is a is a flow diagram illustrating an example set of computer executable operations that may be performed in enhancing an input or interaction using gaze information.

FIG. 27 is a flow diagram illustrating an example set of computer executable operations that may be performed in enhancing a gesture using gaze information.

FIG. 28 is a flow diagram illustrating an example set of computer executable operations that may be performed in enhancing an input using gaze information and a voice command.

FIG. 29 is a flow diagram illustrating an example set of computer executable operations that may be performed in predicting an input using gaze information.

FIG. 30 is a flow diagram illustrating an example set of computer executable operations that may be performed in instructing a system based on a predicted input.

FIG. 31 is a flow diagram illustrating an example set of computer executable operations that may be performed in using gaze information to move between objects in an interface for interacting with multiple objects.

FIG. 32 is a flow diagram illustrating an example set of computer executable operations that may be performed in using gaze information to enhance a touchscreen interface.

FIG. 33 is a flow diagram illustrating an example set of computer executable operations that may be performed in using gaze information to adjust sound properties for at least one recipient.

FIG. 34 is a flow diagram illustrating an example set of computer executable operations that may be performed in displaying multiple points of gaze (POG) on the same screen for facilitating collaboration.

FIG. 35 is a flow diagram illustrating an example set of computer executable operations that may be performed in registering an object in a real world environment using gaze information.

FIG. 36 is an example screen shot of a spectator video feed using gaze information for enhancing interactions.

FIG. 37 is an example screen shot of game play using gaze information for enhancing interactions.

FIG. 38 is an example screen shot of a player screen illustrating interacting with in-game content using gaze.

FIG. 39 illustrates a heads up interface using gaze information for enhancing interactions.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein. Also, the description is not to be considered as limiting the scope of the example embodiments described herein.

As discussed above, knowing where a viewer is looking can provide behavioral insight into the viewer's cognitive processes, since where the user is looking can be correlated to what they are thinking. By incorporating gaze information into an interface or interaction, both with real world objects and virtual objects (e.g., displayed on a screen), inputs and interactions with such interfaces can be enhanced. Gaze information can include gaze direction and point of gaze (POG), both 2 dimensional (2D) and 3 dimensional (3D), as well as pupilometry factors that can be used to determine emotional responses.

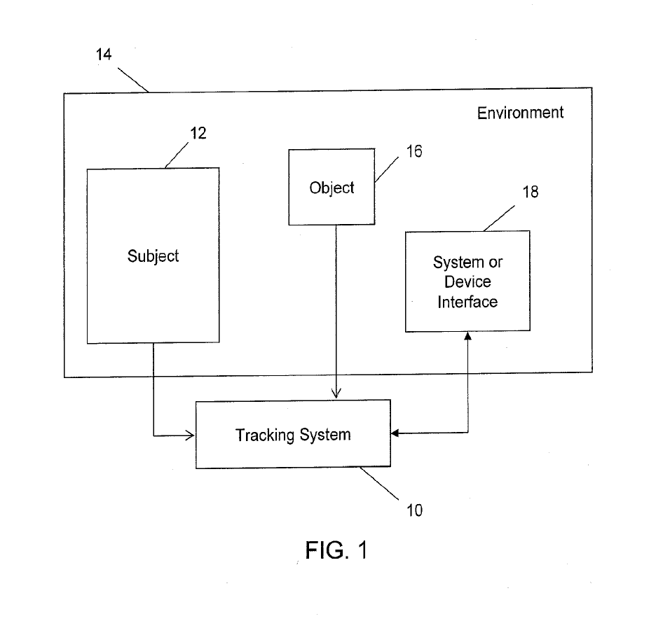

FIG. 1 illustrates an example tracking system 10 that may be used to track both a subject 12 in an environment and how they interact with the environment 14, and objects 16 and system or device interfaces 18 in the environment 14. It can be appreciated that the environment 14 may represent a real world location such as outdoors, a room in a building or house, a computer interface such as a monitor, mouse, keyboard, touchscreen, etc., or any combination of interfaces and objects. For example, an electronic device or light switch in a room may be controlled by an associated system, which is configured to utilize gaze information to enhance a subject's interactions with that device or light switch. It can also be appreciated that although the following examples may suggest an inanimate object 16, the object 16 could also be another human, a remote human (teleconference), or system having artificial intelligence (AI). The tracking system 10 in this example is configured to obtain and track gaze information (e.g. direction, POG, pupilometry, etc.), obtain environment information (i.e. what the environment 14 contains and its nature—e.g., real world 3D objects, content on a display, user interface (UI) elements on an interface, etc.), and track a subject's interactions with the environment (e.g., voice, gestures, physical interactions, etc.).

The tracking system 10 may also be configured to link gaze information to content of interest regions in the environment 14, and to determine context/intent of the subject 12 with respect to the content of interest associated with the gaze information to enhance a user interaction in order to improve the performance and/or naturalness of the interaction or input.

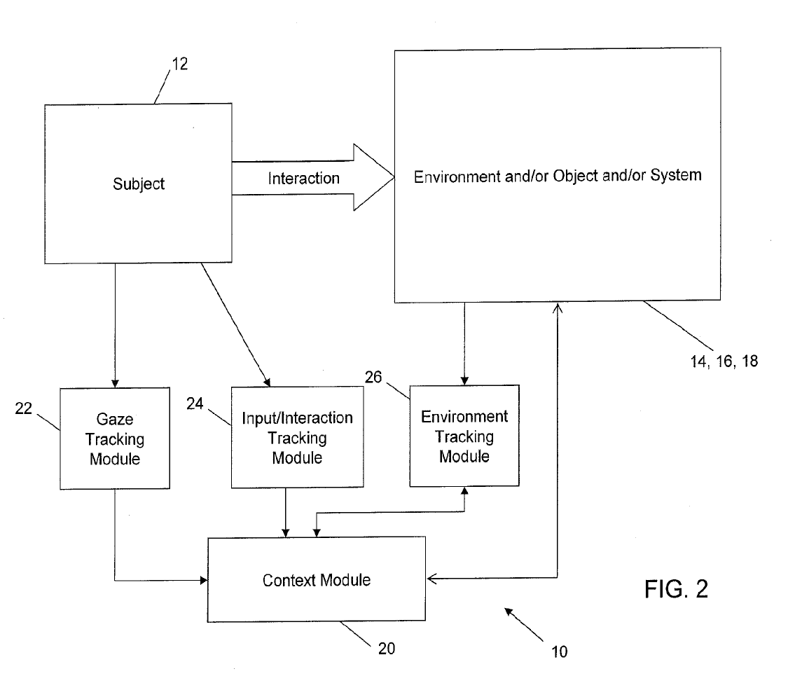

FIG. 2 illustrates an example configuration for the tracking system 10. In the example shown in FIG. 2, the tracking system 10 includes or otherwise has access to a gaze tracking module 22 for obtaining gaze information associated with one or more subjects 12, an input/interaction tracking module 24 for detecting an input or interaction of the subject 12 with the environment 14 and any constituent object 16 or system or device interface 18. The tracking system 10 also includes or otherwise has access to an environment tracking module 26 for determining the nature of the environment 14 being interacted with, such as the objects 16 in the environment 14, any associated systems that control objects 16 in the environment 14, placement of interfaces 18 in the environment (e.g., where input buttons are located on a display screen), etc. It can be appreciated that the tracking system 10 can also be used to provide environment information back to the environment tracking module 26. For example, the gaze tracking module 22 and input/interaction tracking module 24 can be used to have a subject 12 participate in registering and labeling objects 16 in the environment 14.

Also shown in FIG. 2 is a context module 20 which may be used to link gaze information obtained from the gaze tracking module 22 with content of interest determined from the environment tracking module 26, and enhance an input or interaction detected by the input/interaction tracking module 24, or to be performed by the subject 12 in interacting with the environment 14 and/or objects 16 and/or system or device interfaces 18.

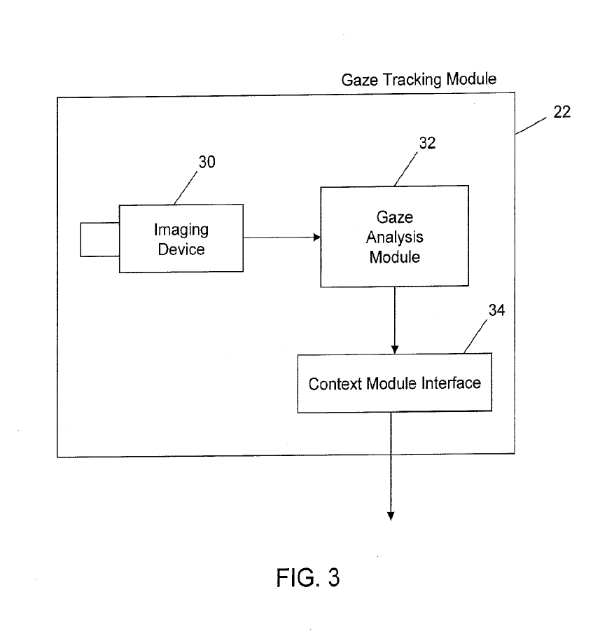

An example configuration for the gaze tracking module 22 is shown in FIG. 3. The gaze tracking module 22 in this example includes an imaging device 30 for tracking the motion of the eyes of the subject 12, a gaze analysis module 32 for performing eye-tracking using data acquired by the imaging device 30, and a context module interface 34 for interfacing with, and providing data to, the context module 20. The gaze tracking module 22 may incorporate various types of eye-tracking techniques and equipment. An example of an eye-tracking system can be found in U.S. Pat. No. 4,950,069 to Hutchinson and entitled “Eye Movement Detector with Improved Calibration and Speed”. It can be appreciated that any commercially available or custom generated eye-tracking or gaze-tracking system, module or component may be used.

An eye tracker is used to track the movement of the eye, the direction of gaze, and ultimately the POG of a subject 12. A variety of techniques are available for tracking eye movements, such as measuring signals from the muscles around the eyes, however the most common technique uses an imaging device 30 to capture images of the eyes and process the images to determine the gaze information.

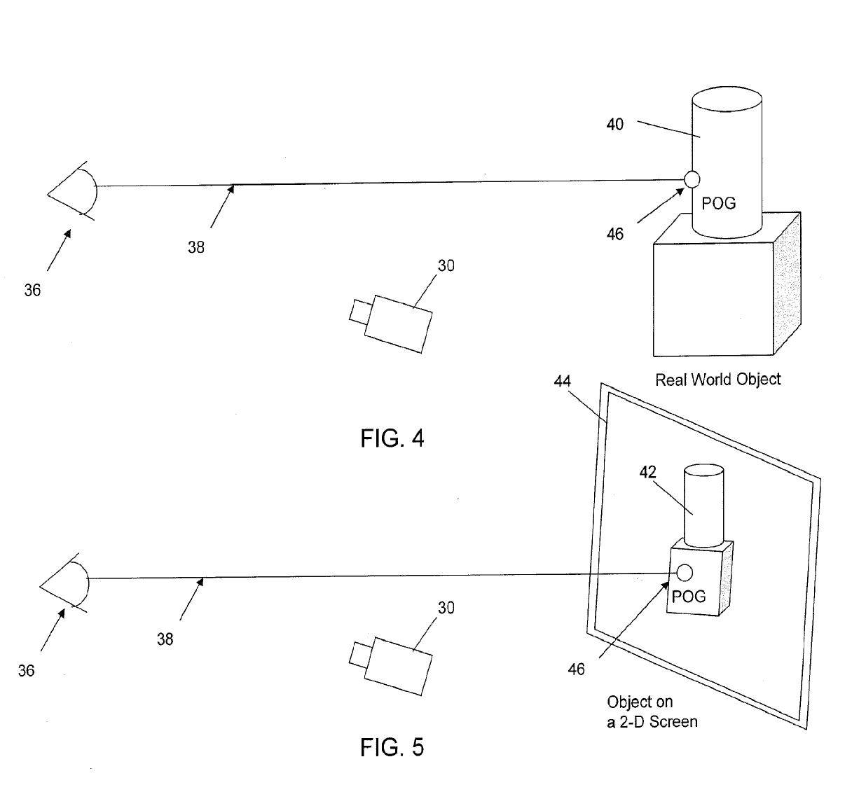

As shown in FIGS. 4 and 5, the direction of gaze, also known as the line of sight 38, is the vector that is formed from the eye 36 to a point on the object of interest 40. The POG 46 is the intersection point of the line of sight with the object of interest 40. The object of interest 40 may be a 3D real-world object as shown in FIG. 4, or a virtual object 42 displayed on a screen 44 as shown in FIG. 5. For 2D displays 44, the POG 46 lies on the surface of the display 44. For 3D displays 44, the POG 46 targets objects 42 similarly to real-world objects 40, using the vergence of the eyes 36, or intersection of the line of sight from both the left and right eyes 36.

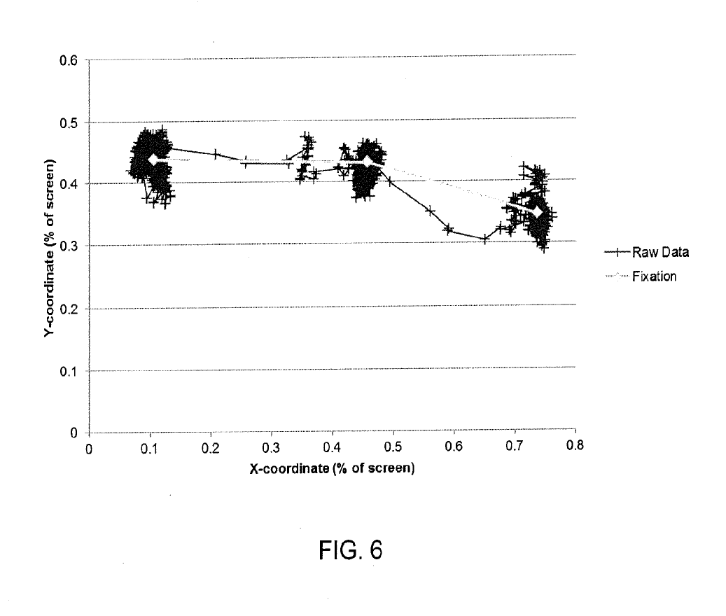

The movement of the eyes 36 can be classified into a number of different behaviors, however of most interest are typically fixations and saccades. A fixation is the relatively stable positioning of the eye 36, which occurs when the user is observing something of interest. A saccade is a large jump in eye position which occurs when the eye 36 reorients itself to look towards a new object. Fixation filtering is a technique which can be used to analyze the recorded gaze data from the eye-tracker and detects fixations and saccades. Shown in FIG. 6 is raw eye tracker output along with output of the filter identifying fixations. It is also possible to estimate the emotional state of the user based on behavioral data such as change in pupil diameter, heart rate, skin conductance, and other biometric signals.

When working with eye gaze information is should be noted that the targeting accuracy of the eyes 36 can be limited due to the size of the fovea. In normal use, the eyes 36 do not need to orient more accurately than the size of the fovea (0.5-1 degrees of visual angle), as any image formed on the fovea is perceived in focus in the mind. It can therefore be difficult to target objects smaller than the fovea limit based solely on the physical pointing of the eyes 36. Various techniques can be used to overcome this accuracy limitation, including using larger selection targets, zooming in on regions of interest, and techniques such as warping the POG 46 to the nearest most likely target based on the visible content (e.g., buttons, sliders, etc).

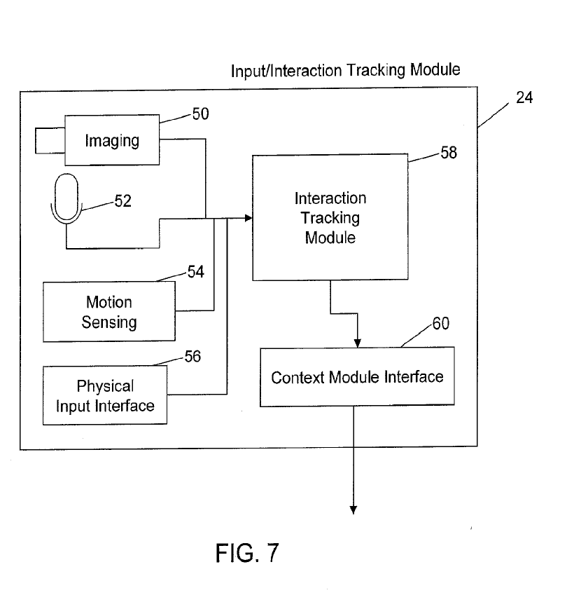

FIG. 7 illustrates an example of a configuration for the input/interaction tracking module 24. In this example, the input/interaction tracking module 24 includes an imaging device 50 for obtaining images or video content of the subject 12, a microphone 52 for capturing sound information such as voice commands, a motion sensing module 54 for capturing motion such as a gesture performed by the subject 12, and a physical input interface 56 such as an interface or connection that is capable of detecting a touch or other tactile input (e.g., touchscreen, mouse click, keyboard entry, etc.). It can be appreciated that other sensors and components may be used to track inputs and interactions of the subject 12 and those shown in FIG. 7 are for illustrative purposes only. The imaging device 50, microphone 52, motion sensing module 54 and physical input interface 56 sense or otherwise obtain information associated with an input or interaction performed by the subject 12 and such information is provided to an interaction tracking module 58. The interaction tracking module 58 in this example gathers and, if necessary, processes information obtained by the tracking module 24 and provides interaction/input information to the context module 20 via a context module interface 60. For example, the interaction tracking module 58 may receive a voice command via the microphone 52, and provide data representative of the voice command to the context module 20 to enable the voice command to be correlated to an object of interest 40 identified using a detected POG 46 for the subject 12.

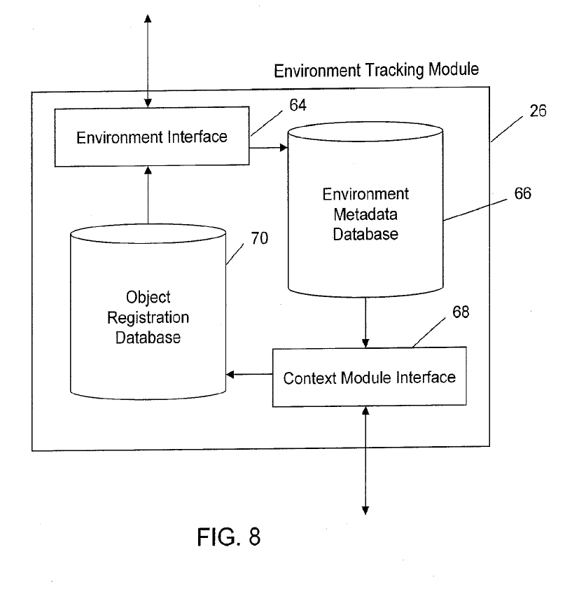

Turning now to FIG. 8, an example of a configuration for the environment tracking module 26 is shown. In this example, the environment tracking module 26 includes an environment interface 64 to enable the environment tracking module 26 to obtain information associated with the environment 14 of interest. For example, the environment interface 64 may interface with a computer to determine where particular UI elements are displayed on a monitor. An environment metadata database 66 is also shown, which may be used to store metadata or other information associated with the environment 14 being observed. For example, the environment tracking module 26 may use the environment metadata database 66 to cache data associated with the environment 14 to avoid having to make multiple requests for data. The environment tracking module 26 also includes a context module interface 68 for communicating environment data to the context module 20 and, if applicable, feeding data from the context module 20 back to the environment 14 (or a system or component associated therewith). For example the context module 20 may be used to register objects in the environment 14 and location data and labels can be generated and fed back to the environment 14 for later use. It can be appreciated that although the location data can be stored by the gaze tracking module 22, data can be fed back in the environment 14. Fore example, a lighting system in a room may adjust colour based on the colour adaptation of the user. An object registration database 70 can be used to store or cache registration data, which may then be fed back into the environment 14.

It has been found that in order to use gaze information to enhance inputs and interactions of the subject 12 with an environment 14, it is beneficial to have obtained knowledge of the environment 14 with which the subject 12 is interacting. The subject's gaze direction and position can then be linked to objects 40 in the environment 14. With the gaze linked to an object 40, the subject's interest may be inferred, and appropriate actions applied to the object 40. The environment 14 of interest may be the subject's real world surroundings, the content in a video shown on a TV, the interfaces on a computer screen, the content shown on a mobile device, etc.

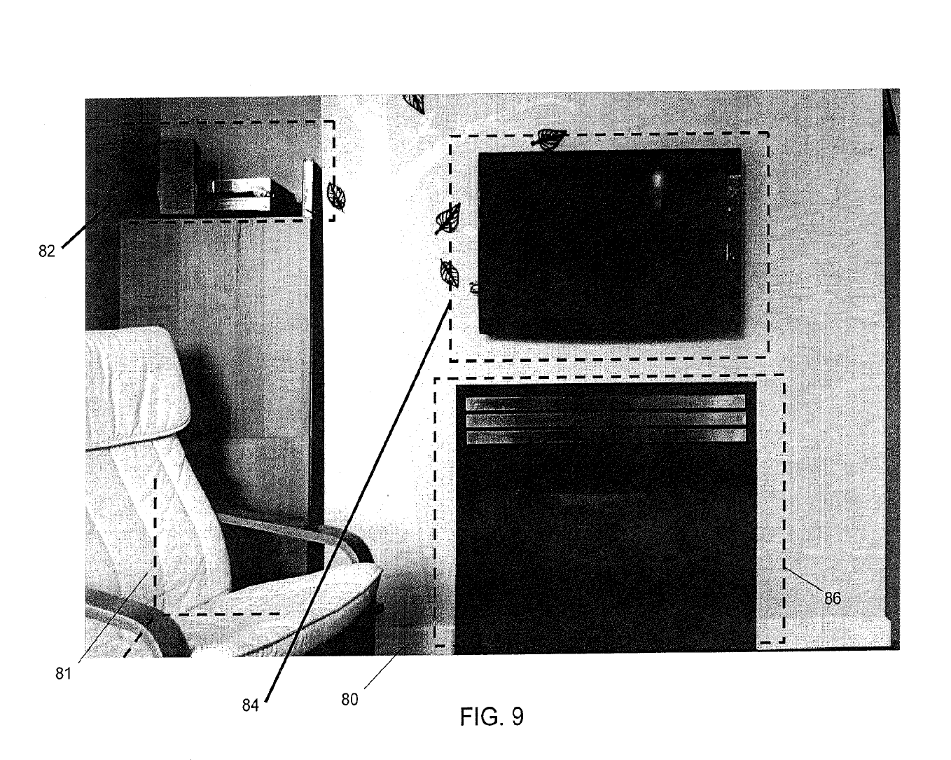

Objects in the real world can be defined by their 3D position (in relation to some world coordinate system 81, e.g. a location associated with the tracking system 10), dimensions, characteristics, available actions (such as lift, move, rotate, switch on/off, etc), among others. A 3D position (X,Y,Z) for the object can then be associated with that object with respect to a world coordinate system 81, and a label identifying the object (e.g., lamp, stereo, light switch, as well as instance if more than one object of a type exists, i.e. lamp1, lamp2, etc) can be generated. For example, as shown in the image 80 of FIG. 9, a stereo 82, television 84, and fireplace 86 are identified, along with actions such as on/off for the fireplace, and channel up/down, volume up/down for the TV, etc.

Objects' physical locations may be temporary, e.g., when tracking other subjects 12 in a room (e.g., MOM, DAD, FRIEND). Object definitions may also include a timestamp for the last known location, which can be updated with the latest position data at any point. Objects can also be registered in the real world manually to identify the location of objects (e.g., with a measuring tape).

A scene camera and object recognition/pattern matching system can be used to identify the location of objects 40 in an environment 14. For example, tools such as the Microsoft® Kinect® can be used to provide a three-dimensional mapping of an entire room. The location of real world objects 40 can also be registered by looking at them and then assigning an identifier to the object 40. For example, looking at a light switch, labeling it LIGHT1, and registering the 3D position for future interaction.

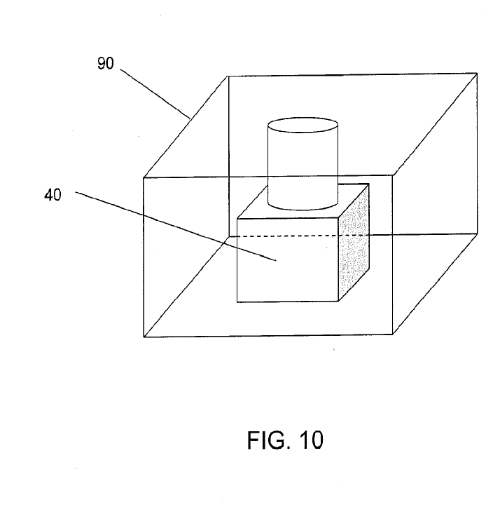

Models of real world objects 40 can also be entered by tagging the position of the 3D POG 46 with object identifiers, such as TV, PHONE, LIGHT SWITCH, etc. Real-world objects 40 occupy variable and irregular regions of space and therefore a single 3D POG may not fully describe an object's position in space. A default object size and shape could be used, where the 3D POG 46 is used to identify the center of the object 40, and a bounding region 90 (box or sphere) of a default dimension aligned with the world coordinate system set to encompass the object as shown in FIG. 10. Object targeting may then be subsequently achieved by having the 3D POG 46 enter the object 40 bounding region 90. In the example above, this means the subject 12 could look at either the top or bottom of the telephone, and in both cases the object ‘telephone’ is identified.

Rather than register the object location 40 with a single POG 46, more accurate object identification can use a sequence of POGs 46 across the object 40 to encompass the object 40 in a more accurate bounding region 90. For simplicity, the bounding region may be a rectangular shape, or spherical shape, although any complex geometric bounding region would work. For a sphere, the target gaze points would include a central point P_{central}, and then points at the extents of the object Pₑₓₜₑₙₜ_{_{—}}ᵢ. A spherical bounding region centered at P_{central}, and encompassing all Pₑₓₜₑₙₜ_{_{—}}ᵢ would then be used to identify the object. In practice, enlarging the region by a fixed amount, such as 10% can be performed to increase the probability that the bounding region 90 encompasses all of the object's features.

For rectangular bounding regions, the gaze positions would include points at the furthest extents of the object 40 in height, width, and depth: P_{width}_{_{—}}ₘᵢₙ, P_{width}_{_{—}}ₘₐₓ, P_{height}_{_{—}}ₘᵢₙ, P_{height}_{_{—}}ₘₐₓ, P_{depth}_{_{—}}ₘᵢₙ, P_{depth}_{_{—}}ₘₐₓ. If there were two points that fully encompass the object 40, such as opposing corners on a rectangular shape, only two 3D POGs 46 would be required to form the rectangular object bounding region 90 aligned with the world coordinate system.

Identification of the object 40 targeted by the 3D POG 46 can be performed by testing the 3D POG 46 for inclusion in the object's bounding region 90 using methods well-known in the field of computer graphics. For example, techniques such as the sphere inclusion test, cube or rectangular region test or polygonal volume inclusion test can be used.

In the event that the target object 40 is at a distance in which the 3D POG 46 is no longer accurate in depth, e.g., the line of sight vectors become parallel, the line of sight ray from the dominant eye may be used. The first object intersected by the LOS ray is the selected object.

It may be noted that content shown on a 3D display 44 may be tracked as described above, in addition to also using computer models of the displayed content. The gaze targeting information may be provided to the computing system controlling the display 44 which already has a detailed description of the environment 14. The computerized environment, used to render the display image (e.g. for a video game), can provide the locations of objects 40 within the scene.

For 2D content such as TV shows and movies, the media image frames may be segmented and content locations identified at the time of creation, and stored as meta data (area regions, timestamps, identifiers/descriptors) as discussed above. Alternatively, content in 2D may be automatically segmented using object recognition/pattern matching, to identify the location of objects 40, e.g. as described in U.S. Provisional Patent Application No. 61/413,964 filed Nov. 15, 2010, entitled “Method and System for Media Display Interaction Based on Eye Gaze Tracking”; and/or as described in PCT Patent Application No. PCT/CA2011/000923 filed on Aug. 16, 2011, entitled “System and Method for Analyzing Three-Dimensional (3D) Media Content”, the contents of both applications being incorporated herein by reference.

For computer generated content such as that used in a video game, the game engine can track the location of objects 40 and identify the positions of objects 40 within the environment 14. For user interface controls on a computing device, the positions can be identified through the operating system, which renders the interface elements, or alternatively, the gaze information can be passed to the running applications themselves, which have knowledge of the content placement. For specialized content such as hypermedia web pages, it is possible to identify content locations by using the document object model (DOM), e.g., as described in U.S. patent application Ser. No. 12/727,284 filed Mar. 19, 2010, entitled “Method for Automatic Mapping of Eye Tracker Data to Hypermedia Content” published as U.S. 2010/0295774, the contents of which are incorporated herein by reference.

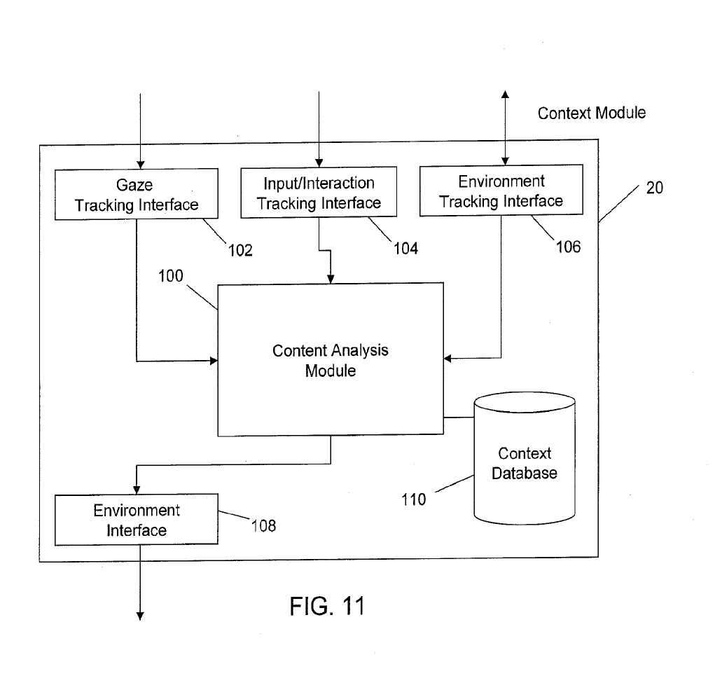

As discussed above, having eye-gaze direction 38, POG 46, and details of the environment 14 it is possible to link the subject's gaze information to content in the surrounding environment 14 using the context module 20. FIG. 11 illustrates an example of a configuration for the context module 20. In this example, the context module 20 includes a gaze tracking interface 102 for communicating with the gaze tracking module 22, an input/interaction tracking interface 104 for communicating with the input/interaction tracking module 24, and an environment tracking interface 106 for communicating with the environment tracking module 26. Gaze information, input/interaction information, and information about the environment 14 may be provided to a content analysis module 100 for determining context and using such context to enhance at least one input or interaction with the environment 14. The context module 20 may also include an environment interface 108 for feeding information back to the environment 14 as discussed above, e.g., by registering an object 40 in the environment 14 and providing metadata for later use. The content analysis module 100 may also include or otherwise have access to a context database 110 for storing any metrics, rules, profiles, or other information that may be used in performing input/interaction enhancements using gaze information.

For 2D displays 44, linking gaze information with an object of interest can be relatively straightforward. For example, if the POG 46 on the screen 44 is located within a particular content region area (rectangle, ellipse, or arbitrary polygon), then the content outlined is deemed to be the currently viewed content.

Targeting on stereoscopic (3D) or mixed reality (virtual and real world) displays can be relatively more complicated, as such targeting typically requires targeting a voxel or volume region in 3D space, rather than a pixel area in 2D space. For targeting objects in 3D environments (real-world, mixed reality and virtual) the 3D POG 46 of a subject 12 may be used. The 3D POG 46 is a virtual point that may be determined as the closest point of approach between the line of sight vectors from both the left and right eyes, or by other techniques for estimating the 3D POG 46. The 3D POG 46 also does not require visual feedback, since the target point should always be where the subject 12 is looking. Without the requirement of visual feedback, a 3D POG selection technique can be used in environments 14 where computer generated graphical display is difficult, such as real world or mixed reality environments 14.

Since the 3D POG 46 is a virtual point, the 3D POG 46 can transit between virtual displays to the 3D real physical world, and back again, allowing for a mixture of real world and virtual interaction. For example, in a standard work desk environment, a user could target the telephone with the 3D POG 46 when the phone rings, which signals a computer system to answer the call through a computer.

Any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the tracking system 10, gaze tracking module 22, input/interaction tracking module 24, environment tracking module 26, context module 20, system 18, etc. (or other computing or control device that utilizes similar principles), or accessible or connectable thereto. Any application or module herein described may be implemented using computer readable/executable instructions that may be stored or otherwise held by such computer readable media.

At this point, the content analysis module 100 has the subject's gaze information, the objects 40 in the surrounding environment 14, and the particular object 40 which has the subject's visual attention, or the object 40 that is currently being observed by the subject 12. It is now possible to interact with these objects 40 in a far more natural way than has been previously possible.

For example, default actions may be pre-designed to enable appropriate behavior based on the object 40 under view and the perceived intent of the subject 12. For example, as will be discussed in greater detail below, looking at a light switch could toggle the room lights from on to off or off to on. Alternatively, if coupled with voice recognition, the subject 12 could gaze at a light switch or TV, and speak a command such as: ‘ON’; and the context of the statement (the object 40 being observed) activated appropriately, such as being turned on or off. Real world objects 40 could also be used as icons for software applications. For example, the home stereo could be used as a metaphor for the computer MP3 player. Looking at the stereo could then be used as an input to start a software-based music player application.

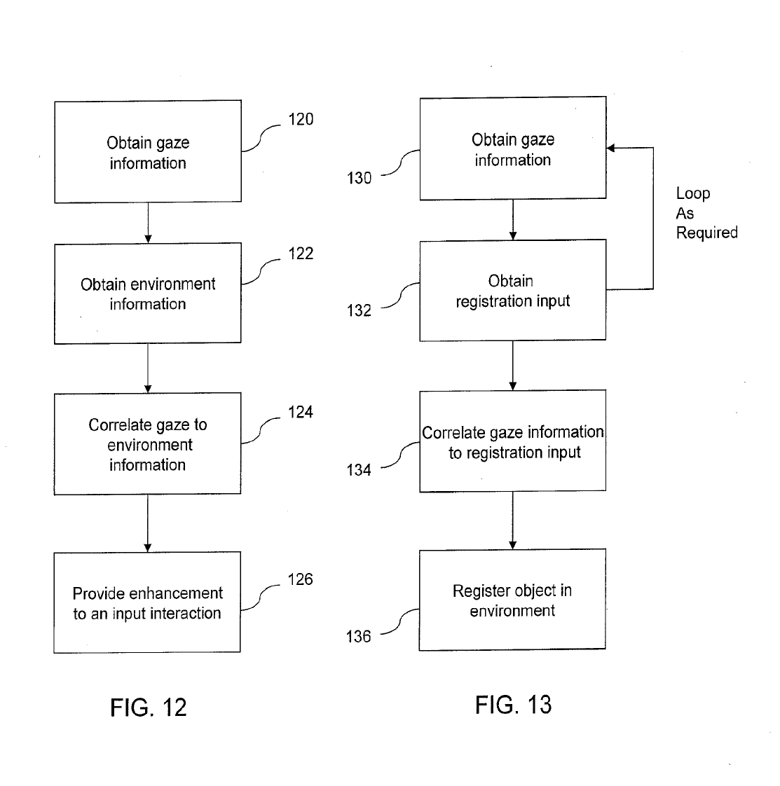

FIG. 12 illustrates an example set of computer executable operations that may be performed by the context module 20 in enhancing an input or interaction. At 120, the context module 20 obtains gaze information by tracking a subject's eyes. At 122, the context module 20 obtains environment data, such as where objects are located in the environment 14. Using the gaze information and environment information, the gaze information can be correlated to the environment information at 124 to, for example, determine an object of interest in the environment 14. The correlation may then be used at 126 to provide an enhancement to an input or interaction with the environment 14. For example, as noted above, an action may be automatically inferred (looking at light=turn light on/off) or the gaze information may be used to couple a gesture or voice command with an action performed on or associated with the object of interest. For example, by looking at a character in a video game and making a passing gesture, a basketball may be thrown to the particular character thus increasing the accuracy of such a gesture.

FIG. 13 illustrates an example set of computer executable operations that may be performed by the context module 20 in using gaze information to register an object 40 in an environment 14. At 130, gaze information is obtained and a registration input is obtained at 132 and this may loop for any number of registration inputs. For example, the subject 12 may indicate with voice feedback that they are looking at one corner of an object to enable the POG 46 to be recorded for that corner. Once the subject 12 is looking at the opposite corner of the object, the subject 12 may provide subsequent feedback to allow the POG 46 at the opposite corner to be recorded. The gaze information may then be correlated to the registration input(s) at 134 in order to define a region or volume boundary associated with the object. The region or volume boundary may then be registered in associated with the object of interest in the particular environment 136. Labeling objects with unique identifiers, such as LIGHT1 and LIGHT2 may help to differentiate the objects in a database, however the subject 12 may simply say “turn on” while looking at LIGHT1, where the particular target light is indicated by the point of gaze and the appropriate light turned on.

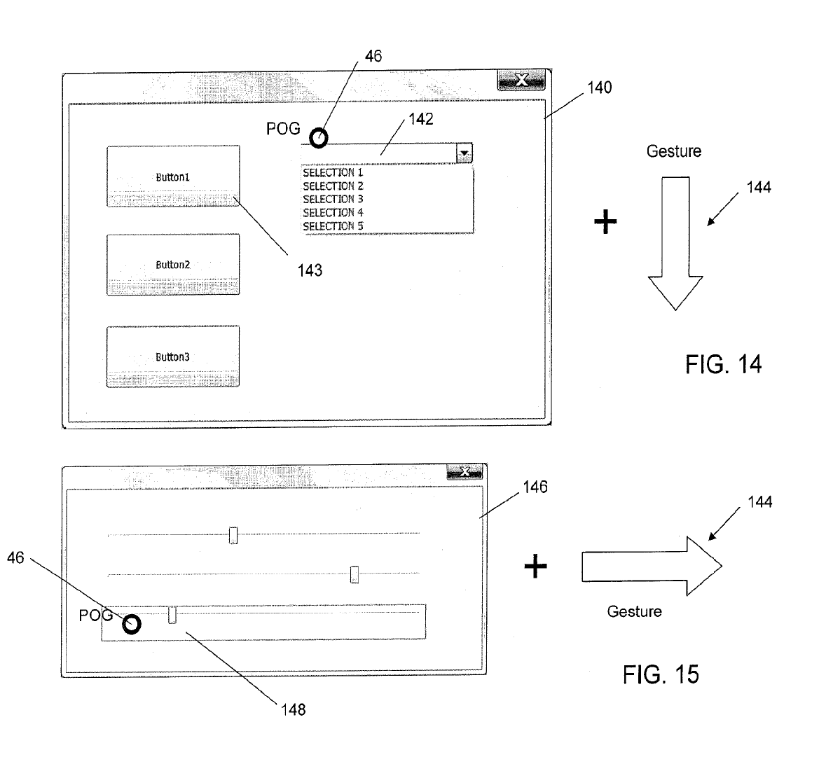

FIGS. 14 through 25 provide various example enhanced inputs or interactions that may be performed using context determined by the context module 20.

Gesture tracking has recently found widespread adoption in human computer interaction. However since the subject's gestures are made in free space, (interaction still takes place on a virtual display), there can be difficulty in identifying with which object 40 in the scene a gesture is meant to interact. A current solution to this problem is to limit the number of objects 40 within the scene that can be interacted with, for example a single virtual pet, or a single opponent. Tracking the subject's gaze information, in addition to tracking gestures, provides a mechanism for directing the gesture action to a particular object 40 or target. For example, if there are two virtual pets onscreen, a petting gesture can be directed towards the pet currently being looked at.

Similarly, complex user interfaces may have multiple controls which are extremely difficult or impossible to interact with using gesture alone. Gaze information can be used to target the control element of interest upon which the gesture action takes place. For example, rotating the hand to the right while looking at the volume knob on a television control panel will increase the volume, while the same gesture performed looking at the channel knob can be used to increment the currently selected channel.

Since gaze may only be accurate to 0.5 to 1° of visual angle, it is possible that the tracking system 10 may have difficulty distinguishing between two control items being looked at if they are located close to one another. If the controls are of a different type, for example if one is a pushbutton and the second is a vertical slider, the form of gesture used to interact with the control can be used to identify which of the two closely positioned controls were intended to be modified. For example, if a mute button is located near a volume slider on a TV control panel, and the gesture is a button pushing gesture, the mute button would be toggled, while if an “up” or “down” gesture were made, the volume would be increased or decreased appropriately.

Most real world and computer interfaces involve a multitude of interface elements, such as knobs, switches, buttons, levers, etc. Physical interaction involves grasping or pushing the desired element and activating it. With virtual interfaces on displays, this physical interaction is not likely possible. For a variety of control elements, potential augmentation with gaze may include buttons, scroll bars or sliders, drop down selections, text boxes, etc.

As shown in the UI screen shot 140 of FIG. 14, a drop down selection may be activated by detecting the POG 46 in an area associated with a drop down box 142. A gesture 144 such as a flick or other movement of the hand in a downward direction may then drop down the selections. Similarly, a button 143 on a UI control can be selected by gazing at the button, with the button 143 potentially being highlighted (not shown) to indicate the active status. Activation may then be a pushing gesture with the hand.

Turning now to FIG. 15, a slider 148 on a UI control can also be selected by detecting a POG 46 on or in the vicinity of the slider 148, potentially highlighted to indicate the active status (e.g. using a bounding box as shown in FIG. 15). Activation may then be a left to right gesture 144. Similar techniques can be applied to vertically and horizontally oriented scroll bars (not shown). It can be appreciated that as explained below, a gesture 144 in combination with POG 46 is only one example. For example, a voice command could also be used to move the slider 148 from left to right or vice versa.

Various other UI elements can benefits from the above principles. For example, text boxes can be activate by detecting a POG 46 on the text box with text input using voice or physical typing using a keyboard.

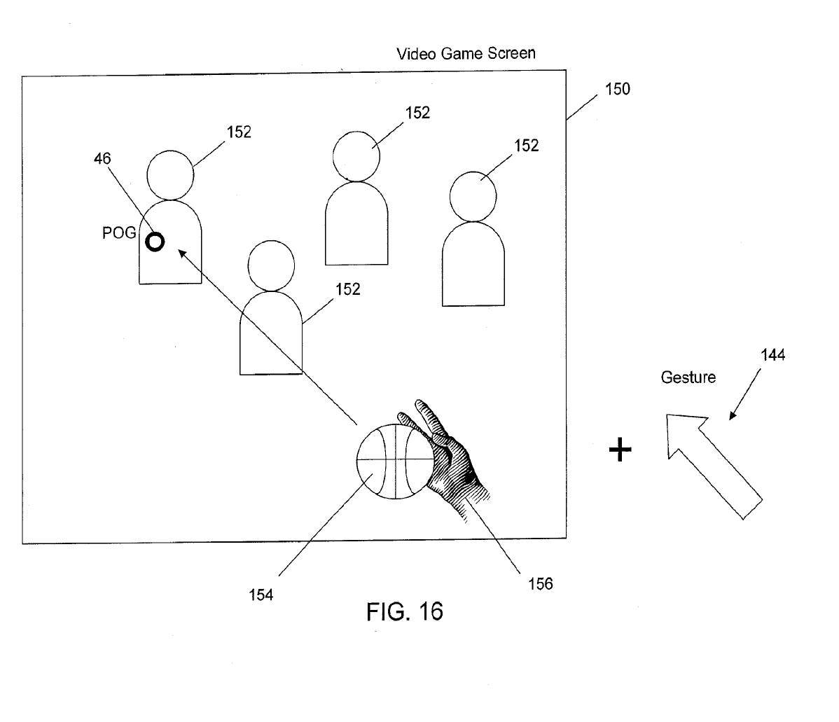

FIG. 16 illustrates another example of the use of gaze information in combination with a gesture. In the example shown in FIG. 16, a video game screen 150 is shown with four potential recipients 152 of a basketball 154 being handled by a subject's virtual hand 156. By detecting POG 46 in association with a particular recipient 152, a throwing gesture 144 can more accurately target the intended recipient. This is advantageous as in current systems, either fewer objects can be used to distinguish between recipients or other measures used such as automatically passing to the closest recipient 152. By using gaze information, a more natural interaction is provided.

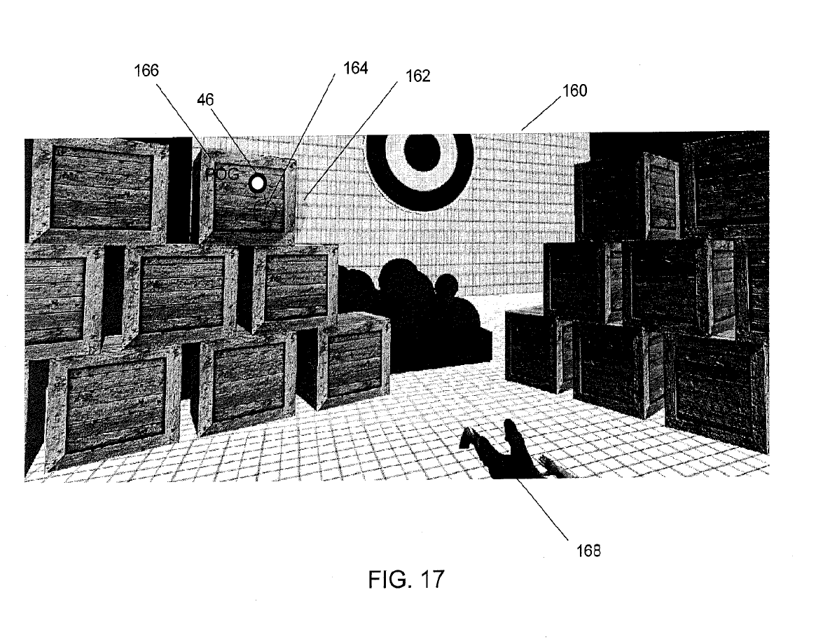

An exemplary video game screen is also shown in FIG. 17, wherein a mind control or levitation move can be achieved using gaze information. In FIG. 17, it can be seen that the environment 14 is cluttered with object and thus traditional gestures would not likely be able to pinpoint a desired object (such as the highlighted box 166) without some physical input (such as that from a mouse or stylus). In order to provide an enhanced experience, the POG 46 can target one of the multitude of objects in the 3-D environment 14, in this example the box 166 that is highlighted 162 and includes a target 164. By selecting the desired box 166 using POG 46, a selection can be made as if it were performed using a thought. The box 166 may then be lifted and translated about the scene using gestures of the arm. The box 166 may then be released with another “thought” when the object is positioned or thrown to the desired place. The selection control may be a voice command such as ‘select’ a gesture, or even an actual brain wave signal from an electroencephalograph (EEG) tracking system.

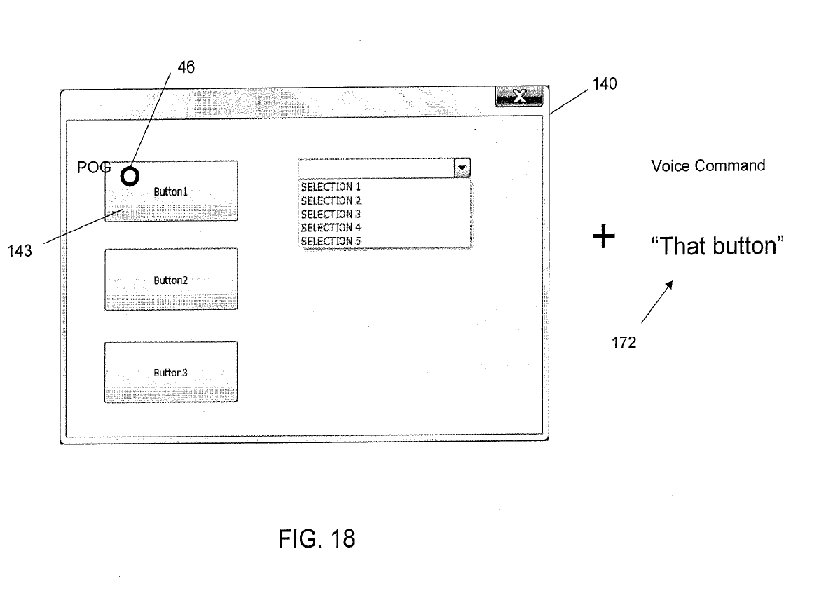

As noted above, voice commands can be used in addition to or instead of gestures in combination with gaze information to enhance an input or interaction. FIG. 18 illustrates the same UI screen 140 as shown in FIG. 13 and in this example the POG 46 is directed to the button 143. Instead of using a pointing or pushing gesture 144 as discussed above, it can be appreciated that a voice command such as “that button” or “select that one” could be used. The use of gaze information allows more natural, and less precise language to be used to make selections.

In other words, gaze information enables the ability to use natural language constructs such as determiners, used in clarifying the noun in a sentence. In particular, demonstrative determiners, such as this, that, these, and those. For example, the command ‘Click that link’, where the web link in question is the one being looked at by the speaker.

It is also possible to augment voice input with gaze information, wherein voice recognition is used to enter basic text, and at the same time on-screen icons allow the user to input non-text commands such as looking at the capital letter command control, while saying “main street” would enter “Main Street”. Other punctuation and hard to pronounce symbols (‘}’, ‘[’, ‘&’, etc) may also be entered using gaze to select from on-screen menus.

It has been found that a common problem with voice recognition, is often a lack of accuracy inherent in the system, wherein voice-recognition is typically only 95% accurate. This low accuracy may be due in part to system performance, but is also from phonetically similar words, such as ‘too’, ‘to’ and ‘two’ or ‘may be’ and ‘maybe’. When the system detects that a recognized word has a high probability of being two different words, a pop-up dialog may present both words and the correct word selected by simply looking at the desired word.

Correcting an incorrectly entered word using voice alone requires a voice command such as ‘correct ‘word”, then restate, respell, or choose the correct word from a list. This can be problematic as the incorrectly spelled word, by definition, is troublesome to the voice-recognition system to understand, and therefore the ‘correct ‘word” statement does not always correctly catch the desired word to fix. There may also be multiple instances of the correct and incorrect word in the paragraph. By simply looking at the word that needs to be corrected, and stating ‘correct’ the system can understand which of the word needs to be corrected.

As well, placing the caret (position of text input) is very difficult using voice only, however with gaze to augment voice input this becomes much easier. For example, in the paragraph above there are eight instances of the word ‘the’. To place the caret next to the fifth instance one need only look at the correct word and command the system to begin text entry from there.

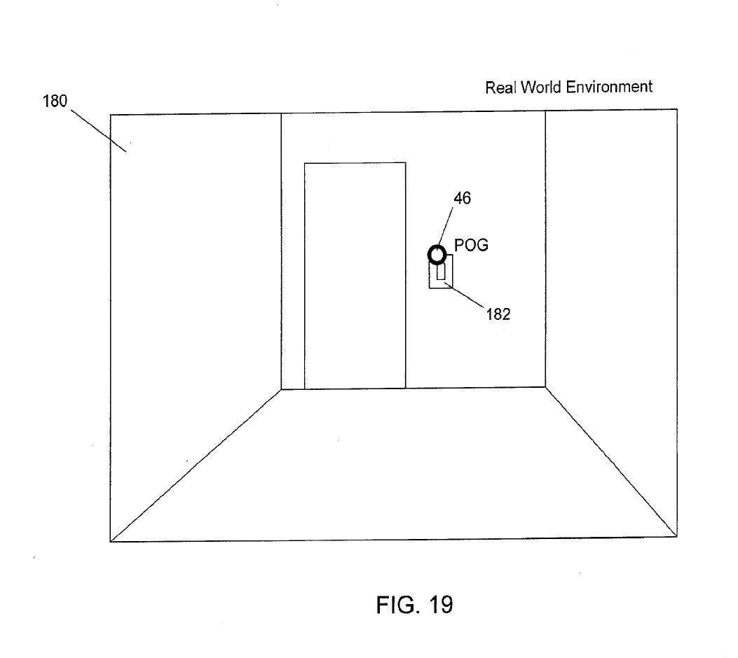

FIG. 19 illustrates an example of a model of real world environment 14 that includes a light switch 182 in a generic room 180. Given that the light switch in this example includes a binary input, it is possible to use gaze information and an expected input to effectively use a thought to control an object 40. For example, if the lights in the room are current ON and the subject 12 is about to leave the room 180, they could simply gaze at the light switch 182 and, by detecting a fixation on the light switch 182, e.g. by detecting a relatively steady position for the POG 46, the context module 20 could infer that the subject 12 wishes to have the light switch 182 turned OFF. It can be appreciated that such principles apply to any binary input mechanism, e.g. TV ON/OFF, etc. It can also be appreciated that the registration process discussed above can also be used to enable a user to pre-register automatic operations to be triggered by gaze alone. For example, a subject 12 may wish detection of POG 46 on a blind or other window treatment to trigger partial opening to permit some sunlight to enter such as in the morning. In addition to spatial cues, temporal cues can also be used. For example, gaze on an object 40 detected in the morning can trigger one operation while gaze on the same object in the evening could trigger another operation.

Accordingly, it has been found that where someone is looking is often closely tied to what the person is thinking about. Knowledge of which object the subject is looking at enables predictive behavior, or the ability to anticipate the subject's desires. For example, the tracking system 10 could track how many times a subject 12 looks at the bright portion of a screen and then quickly looks away again. After a while this might be an indicator of excessive screen brightness and the screen might dim a bit automatically. Similarly, the tracking system 10 can track if the subject 12 has looked at bright real world objects (lamps, windows) and use that information to gently increase screen brightness (compensating for higher adaptation levels).

As well, brain computer interfaces are becoming more common, such as the OCZ® brand Neural Impulse Actuator® which measures the brains EEG signals and converts them to usable signals. While there is still much progress to be made in this technology, these devices have reached the state where brain activity can toggle between binary states with reasonable reliability. A brain controlled ‘select’ function allows for gaze to direct interest and thought to select objects for further interaction.

The keyboard and mouse have been the main form of computer input for many years. The keyboard provides a means for entering text into a computer, as well as generating explicit commands (such as ‘Alt-Printscreen’ to capture the screen). The mouse provides the ability to easily target points on a 2D display, as well as entering commands such as ‘left click’. Both techniques require somewhat artificial actions using the hands.

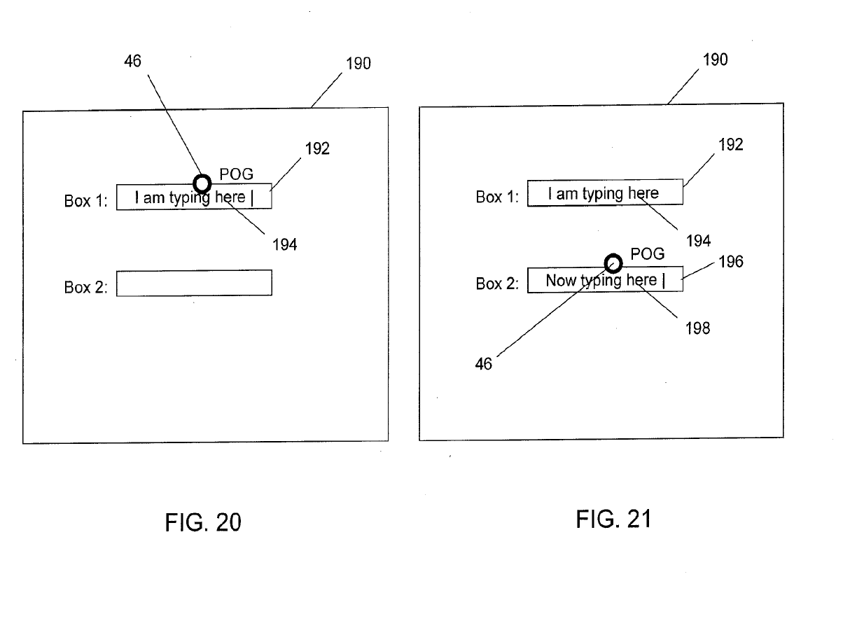

With gaze information, it is possible to augment the use of the keyboard and mouse creating a more efficient interface. When entering text with the keyboard, one may frequently remove one hand from the keyboard to use the mouse for a pointing task. Using only the eyes, it is possible to redirect the focus while both hands remain on the keyboard. For example, entering text into one application, then looking at another to begin entering text in the second application. Another example, shown in FIGS. 20 and 21 would include entering text 194 into a first textbox field 192 in a computer UI 190, then simply looking at the next textbox field 196 to give it focus by shifting the POG 46 towards the next textbox field 196 without having to use the mouse to point out the next textbox and continue typing text 198.

Eye-gaze is also typically very fast, and by its nature the point of gaze is meant to always point directly where you are looking without having to make any explicit commands. This can be used to augment the mouse movement, where the eye gaze roughly positions the cursor near the point of gaze, and the mouse is used for finer pointing (as gaze typically has accuracy limitations of 0.5-1 degrees).

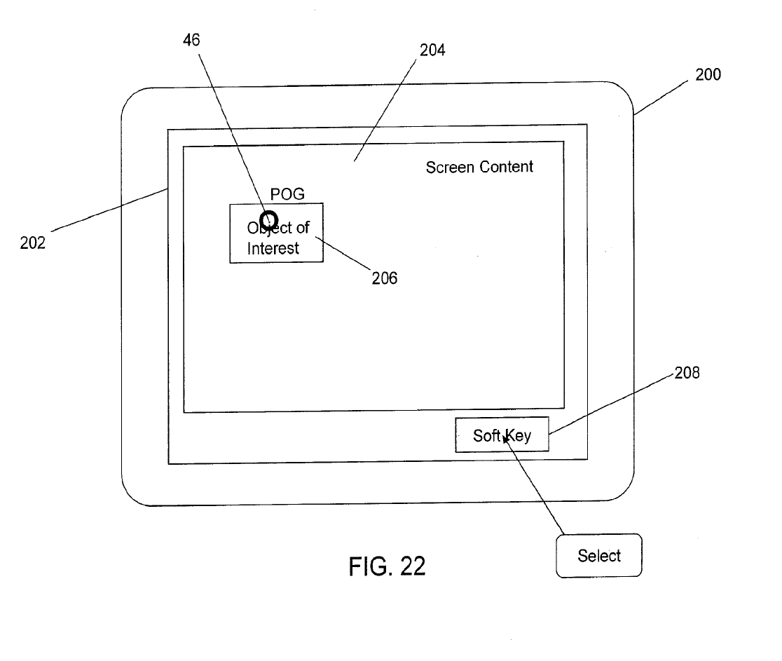

Touch interfaces, e.g., a touch display 202 on a tablet computer 200 as shown in FIG. 22, provide a natural mechanism for interacting with virtual content on the display 202 using the fingers and hands. Eye-gaze can be used to improve the interface with a variety of enhancements. Touch interfaces typically require the fingers to move around the display 202, obscuring elements of the screen content 204. With eye-gaze it is possible to target the screen object of interest 206 with the eyes while touching an offset area of the display 202 which does not intrude on the portion of the display being viewed. For example, as shown in FIG. 22, to launch an application, rather than have to touch the display 202 over the position of the application icon 206, simply looking at the application icon 206, and pressing a soft key 208 or other button elsewhere on the touch display 202 can provide the same input as tapping the application icon 206. Alternatively, with the addition of voice-recognition, looking at the application icon 206 to provide a POG 46 that coincides with the application icon 206, and stating ‘run’ or ‘activate’ could be used to launch the application if the hands are already occupied with other tasks, such as holding the device.

As touch displays get larger, it may become difficult to reach all areas of the display with the hands. Similar to the description above, the subject's gaze may be used to target content on the touch display while local hand movements are used to draw the remote object closer for further interaction. Another example is to look at a particular picture in a large array of picture thumbnails, and make a pinch to zoom finger motion anywhere on the display, which shrinks or expand the particular image being looked at.

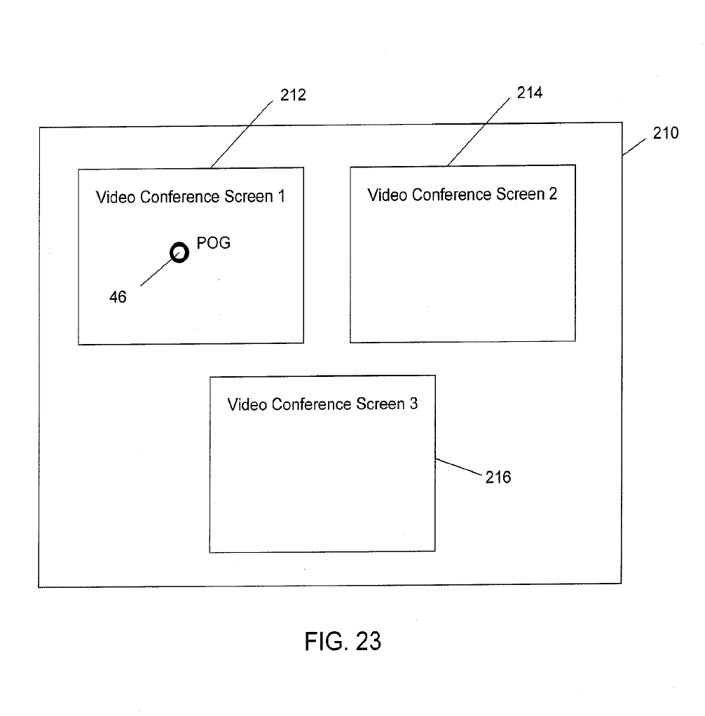

Sound properties such as volume can also be controlled automatically using gaze information as shown in FIG. 23. In the example shown in FIG. 23, first, second, and third video conference screens 212, 214, 216 are shown, each showing a participant in a video conference. To assist in directing a subject's voice more clearly to an intended recipient, the tracking system 10 can be used to detect a POG 46 in associated with a particular participant, in Video Conference Screen 1 in this example. The volume directed to that participant may then be adjusted at the participants end in order to emphasize who the subject 12 is speaking to. Similarly, the other screens 214, 216 can be blurred or darkened temporarily to further emphasize who the subject 12 is speaking to. When communicating in a networked environment 14 such as during a video conference, the POG 46 associated with who is actually speaking can be used to adjust volume and display properties in the applications used by each participant in order to enhance the experience.

It can be appreciated that various other enhancements are possible. For example, a display can be augmented based on where someone looks. For example, when looking at a display, based on where one is looking, the scene could be rendered at the highest resolution and the remainder at a lower resolution, then slowly fill in the peripheral at higher resolution with excess bandwidth. Such control can be advantageous for bottlenecked bandwidth or rendering power. In another example, since where someone is looking is closely tied to what they are thinking, it is possible to enhance the experience by transmitting appropriate smells to the user based on the objects being viewed. For example if you're watching a television show and you look at a bowl of strawberries, a strawberry smell may be emitted from a nearby smell generating system. In another example, a video game may include a bakery with a display case showing several baked goods. Gaze information can be used to emit a smell corresponding to the item of interest to enhance the selection of something to eat in a virtual environment 14. Similarly, gaze information can also be augmented with other types of feedback such as haptic feedback. For example, by detecting that a subject 12 is viewing a shaky or wobbly portion of television or movie content, the context module 20 can instruct an appropriately outfitted chair or sofa to shake or vibrate to enhance the viewing experience.

As discussed, enhancing interaction with eye gaze can greatly improve the ease of use and naturalness of the interface. Activities such as working, playing and communicating may all benefit from gaze-based interaction enhancements. However, of particular benefit from the addition of gaze is computer supported communication and collaboration.

In natural human to human communication, gaze provides a powerful channel of information. Where one is looking is closely tied to the current interest of the individual, and therefore humans have evolved the ability to fairly accurately determine where someone is looking, to gain insight into the other's thought processes. This insight provides faster communication and a better understanding between individuals.

There are many computerized tools for supporting collaborative work, such as e-mail, videoconferencing, wiki's, etc. Unfortunately, the powerful human-to-human communication channels are often lost with these tools. Emulating these communication channels through computerized tools can be limited: for example, emoticons in e-mails are poor replacements to real facial features.

When collaborating, it is particularly valuable if one individual can share their intent with others without having to be explicit. With shared context, or intent, communication is faster, simpler, easily understood, and less likely to be incorrectly interpreted. For example, in a group discussion one participant can indicate they are talking to another by simply looking them in the eyes. Using gestures is another method for sharing intent: for example, if a team is reviewing an architectural drawing on a large display, the lead designer could point to the drawing and say ‘We need to remove this door’ and ‘over here, the window needs to be enlarged’. The intent or context of his statements (‘this’ and ‘here’) are inferred from the pointing gestures he made on the drawing.

Where someone is looking is often very closely tied to what they are thinking and provides the ability to better understand the context of their discussion. Eye-gaze can be tracked and used as a context-pointer for computer supported collaborative work. When communicating over a computer, for example using Skype to collaborate with a colleague in a distant office on a financial spreadsheet, the point-of-gaze context pointers of each participant may be graphically displayed for other participants to see which spreadsheet cells have the other participants focus, or used by the computer system to react based on an assumption on the participants intent.

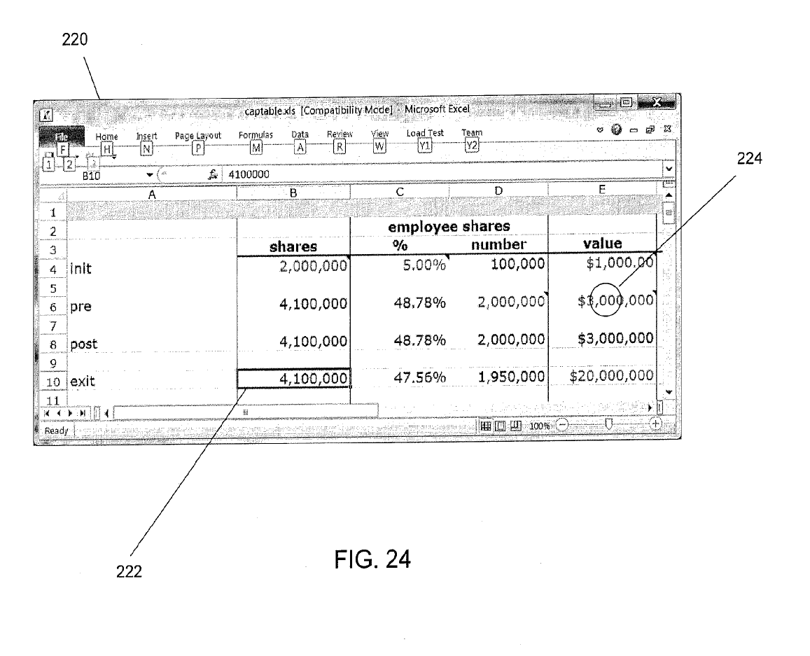

In FIG. 24, collaboration on a spreadsheet 220 is shown enhanced with a context pointer 224. One participant is operating the keyboard and mouse and is entering data into cell B10 222. The context pointer 224 of the second participant indicates where they are looking and signals to the subject 12 which cell needs to be edited next (in particular if the collaborators are also communicating by voice at the same time—e.g., next we should go “here”). When used for control, a statement such as ‘Fix this cell’, could also directly activate the cell of interested for editing.

Observing where the attention is focused provides context to generic statements as described above, and can provide insight into the participants thought processes. The context pointer 224 may be colored differently for each participant, take on different shapes, and have sufficient transparency so as not to obscure the display. Context pointers 224 can be used in real-time as well as recorded for off-line viewing. While most displays are 2D, the context pointer 224 may also be used with 3D displays if a 3D eye-tracker is used. When operating in 3D, the context pointer can also target content at varying depths.

While the context pointer 224 provides insight into the intent of a user to other participants, it may also be used as a mechanism for control. As the context pointer 224 is positioned where a user is looking, it can be used to interact with content at that location. For example, in addition to pointing at the architectural drawing in the example above, as the designer looked at the door and window, he or she could say ‘highlight this and this’, and, coupled with voice recognition, the CAD design would subsequently mark the window and door for re-design, possibly by highlighting them in yellow.

The type of collaboration that involves participants who are physically located in close proximity, such as computer workstations located side-by-side, is common. Examples include when two individuals are reviewing a spreadsheet, or participating in pair programming. In each case, the context pointer 224 can be used as an indicator of the other participant's attention point. As a control tool the context pointer may also be used to control the focus of the keyboard or mouse

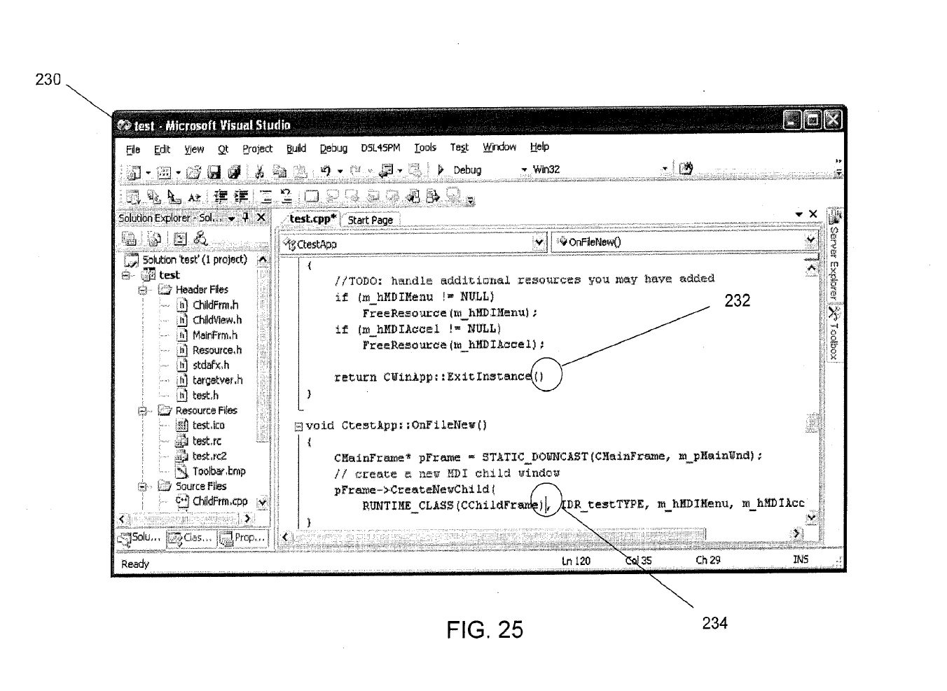

Shown in FIG. 25 is a screenshot 230 of a code review or shared programming task. One programmer is on the keyboard (in control) while the other participant helps work through the algorithms. In FIG. 25, context pointers 232, 234 for two programmers are shown. The first programmer associated with context pointer 234 is working on a particular section of code, when the second programmer associated with context pointer 232 notices a semicolon “;” was missed on line 95, and rather than having to state ‘You missed a semicolon at the end of the line 95”, the second programmer could say ‘correction needed’ and the position is immediately inferred from the gaze location. Simply lingering with the context pointer 232 over errors may be sufficient to indicate to the other programmer 102 to take a closer look.

Telecommuting is increasingly common, and the context pointer 224 can be particularly useful when used in remote collaboration such as videoconferencing where physical gestures are no longer possible. For example, a technician with an online helpdesk could gain significant insight into troubleshooting a remote user's problem if, in addition to their screen, the technician could also see where the remote user is looking.

In a many-to-one example, a lecturer in an auditorium theater may be able to graphically see where the audience is looking on the presentation slideshow and direct the lecture appropriately (emphasizing content that is attracting more attention). Likewise the audience may be able to see where the lecturer is looking (perhaps from a confidence monitor, which is then mapped to the display screen) without having to resort to laser pointers. As a control tool the context pointer 224 may be used to indicate when to proceed to the next presentation slide.

In a training example for off-line applications, the context pointer 224 of an experienced pathologist may be recorded while they are looking for cancer artifacts in a tissue slide. Future student pathologists may then review the recorded context pointer path to see what elements of the image caught the attention of the specialist and bore further detailed inspection.

The use of data fusion by the military results in increasingly complex images, such as multiple layers of data overlaid on maps. It is particularly important that the context of given instructions relating to these maps are well understood, and the use of the context pointer 224 allows for improved contextual understanding.

Multiplayer video games often require the coordination of large groups of participants. The context pointer 224 can be a beneficial tool in planning a campaign as described above for the military, however it can also be used to assist in contextual understanding of orders during the mission. An example in a war-based video game, would be the command ‘you three, attack him’, where ‘you’ are identified by the context pointer as three particular members of the team, and ‘him’ is the enemy targeted by the context pointer.

In multiplayer games such as virtual life games, the context pointer 224 can be used to indicate which avatar you are in dialog with, replacing eye contact. In a crowded room, the directed gaze can also be used to direct the audio to a specific avatar, identified by the users gaze position.

In a business context, a negotiation may be assisted using the context pointer 224 to indicate where one party or the other is paying particularly close attention to in a contract or deal spreadsheet. While it may not be desirable to share this information with the negotiating party across the table, it may be valuable to show the context pointer 224 to the lead negotiator's remote assistants, who can then supply pertinent information based on the negotiators focus. Recording the context pointer 224 for future review may also allow for analysis of performance or for training future negotiators.

When a gaze tracking module 22 is capable of estimating the line of sight and POG 46 in 3D, it is possible to use the context pointer 224 in real-world environments. The 3D context pointer (not shown) can indicate which real world objects have attracted a subject's attention. For example, in a large meeting, one participant can signal who they are talking to by making eye contact, which then can control the orientation of directional microphones and speakers appropriately. If a participant in the meeting is remote, the context pointer 224 can be graphically overlaid on their display of the meeting to indicate who the speaker is talking to at all times.

Similar to the concept of training novice pathologists by using gaze patterns from experts, the 3D context pointer in the real world can be recorded, along with the real world scene, to highlight objects that hold the focus of attention. This information is of particular interest to professional athletics (insight into anticipation), military training (situational awareness), and a diverse range of other disciplines.

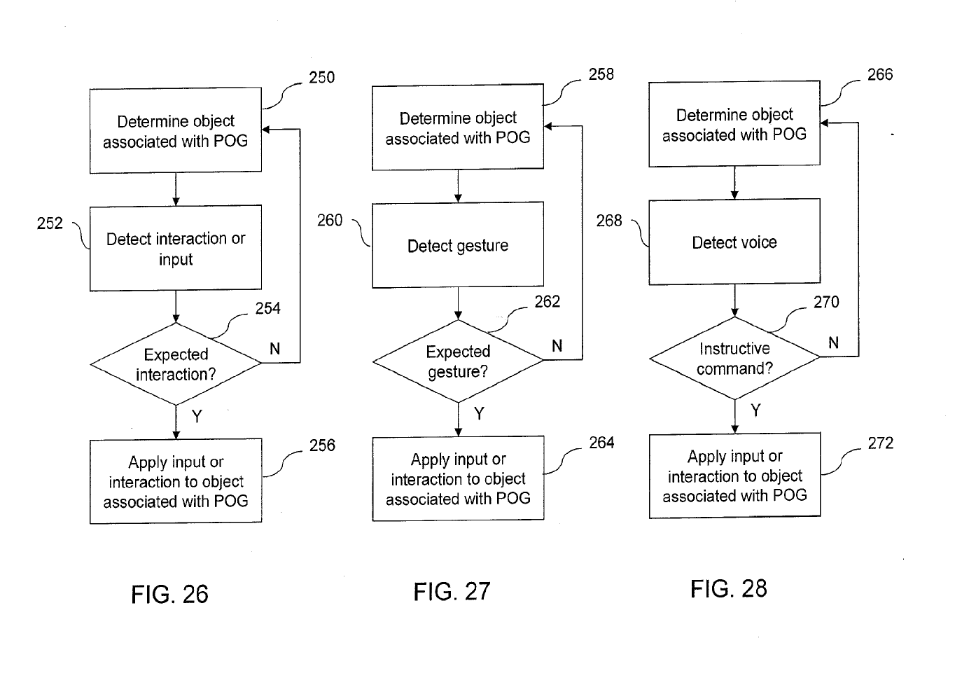

FIGS. 26 through 35 illustrate computer executable operations that may be performed by the tracking system 10 in utilizing gaze information to enhance inputs and interactions with an environment 14 and objects 16 and systems 18 within the environment 14.

FIG. 26 illustrates an example of a set of computer executable operations that may be performed in augmenting gaze information such as POG 46 with various interactions or inputs. At 250, the context module 20 determines an object 40 in the environment 14 of interest which is associated with the POG 46. For example, the context module 20 may detect that the subject 12 is currently gazing at a particular character shown on a video game screen. At 252, the context module 20 detects an interaction or input made by the subject 12, e.g., by receiving an input from the input/interaction tracking module 24. At 254, the context module determines if the detected input or interaction is expected. In the above video game example, a detected cough or other sound may be considered an input or interaction but may not have relevance in the current context. On the other hand, in a motion sensing based video game system, a gesture made by the subject 12 may be an expected “move” or action associated with video game play. If the detected input or interaction is not expected or can otherwise be ignored, the tracking system 10 may return to tracking the POG 46 at 250. If the detected input or interaction is expected, the input or interaction is enhanced or augmented using the gaze information such as POG 46 at 256. For example, the POG 46 can be use to more accurately pass a ball to a recipient that is being looked at by the subject 12.

FIGS. 27 and 28 illustrate two example embodiments of the operations shown in FIG. 26. In the gesture example of FIG. 27, an object 40 associated with the detected POG 46 is determined at 258, and a gesture is detected at 260. The context module 20 then determines at 262 if the detected gesture is an expected gesture. For example, an interaction with a stereo knob may expect a rotation of the subject's hand. If the gesture is an expected gesture, the input or interaction associated with that gesture can be enhanced using the POG 46 at 264. In the voice example shown in FIG. 28, an object 40 associated with the detected POG 46 is determined at 266 and a voice input is detected at 268. The context module 20 may then determine at 270 if the voice content detected at 268 is expected. For example, in the current scenario, a command such as “this” or “shoot” may be expected and detection of a cough conversational speech can be ignored. If the voice content is expected, the input or interaction associated with the voice command (or the POG 46—e.g. where the POG 46 is used to highlight an input, etc.) can be enhanced using the POG 46 at 272. It can be appreciated that similar logic may be applied to other inputs or interactions and FIGS. 27 and 28 are illustrative only.

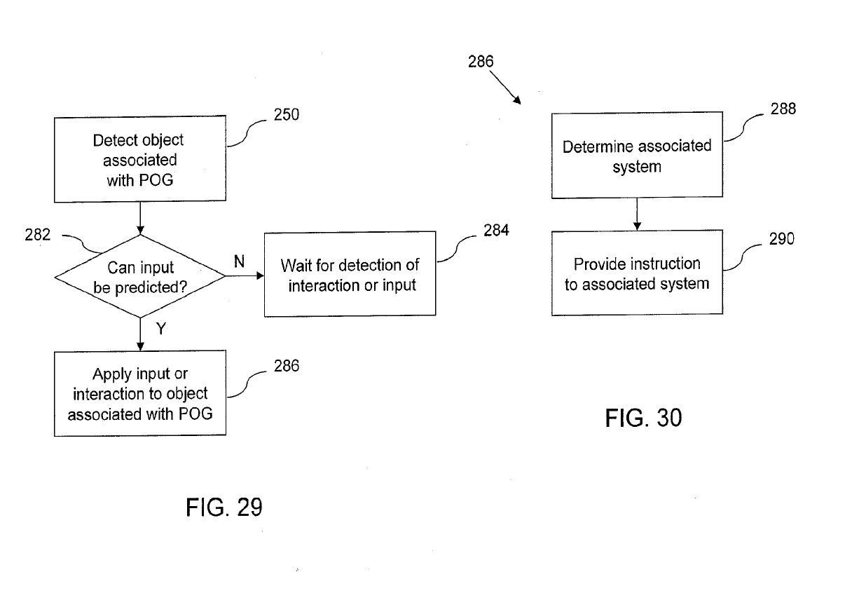

FIG. 29 illustrates an example set of operations that may be performed by the tracking system 10 in using gaze information to predict an input to be applied to an object 40 or system 18. At 250, the context module 20 detects an object 40 associated with a detected POG 46 and determines if there is an input to the object 40 that can be predicted at 282. For example, as discussed above, by gazing at a light switch 182, the context module 20 may be able to infer that the subject 12 wishes to either turn the lights on or off depending on the current state of the lighting system. If an input cannot be predicted based on the gaze information, the tracking system 10 can revert to waiting for the detection of an input or interaction at 284, such as a gesture or voice command as shown in FIGS. 27 and 28. If an input can be predicted using the gaze information, the input or related interaction can be applied to the object 40 or a system 18 associated with the object 40 at 286.

FIG. 30 illustrates an example set of operations that may be performed in instructing a system 18 or an object 40 to perform an input or interaction based on gaze information. For example, the operations shown in FIG. 30 may be applied during step 286 in FIG. 29 or steps 256, 264, or 272 in FIGS. 26, 27, and 28 respectively. At 288 the context module 20 determines an associated system 18 to be interacted with (e.g., a lighting system associated with a light switch 182) and provides one or more instructions to the associated system at 290. It can be appreciated that more than one system may be instructed at the same time. For example, detecting a subject's gaze on a smart home panel can instruct default settings for lighting, window coverings, music, etc.

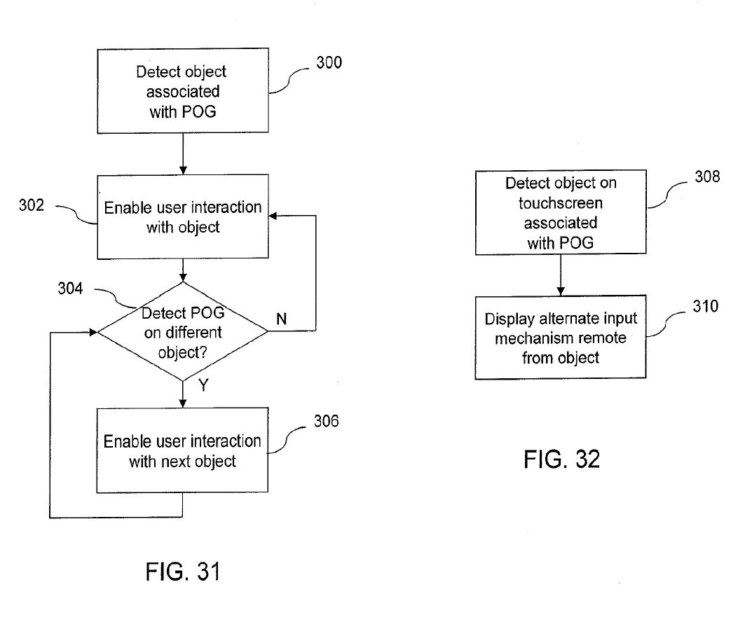

FIG. 31 illustrates an example set of operations that may be performed in using gaze information to navigate between elements in an UI. At 300 the context module 20 detects an object associated with the POG 46, e.g., a first text entry box 192 as shown in FIG. 20. The context module 20 may then communicate with an application providing the UI object to enable the subject 12 to interact with the detected object (e.g., enter text into the entry box 192) at 302. In order to enable the subject 12 to seamlessly interact with another object without requiring additional inputs such as a touch or mouse click, e.g., to enable the subject 12 to continue typing in a different entry box or to switch between two open application windows, the context module 20 can monitor gaze information tracked by the gaze tracking module 22 to detect a switch of the POG 46 to be associated with different object at 304. Once the POG 46 is directed at a different object, the context module 20 may then communicate with the application providing the UI objects to enable the subject 12 to interact with the next object at 306.

FIG. 32 illustrates an example set of operations that may be performed in enhancing touchscreen interactions. At 308 the context module 20 detects that the subject 12 is gazing at an object on a touchscreen, e.g., the object of interest 206 on the touchscreen 202 shown in FIG. 22. Upon detecting that the POG 46 is on a particular object of interest 206, the context module 20 may then display an alternate input mechanism that is remote from the object to facilitate selection of the object of interest 206. For example, as shown in FIG. 22, a soft key 208 may be displayed at the edge of the touchscreen 202 to facilitate selection of the object of interest 206. Such a soft key 208 may be particularly advantageous where the touchscreen 202 is relatively small and thus can avoid the subject 12 having to zoom in on the object of interest 206 (e.g., a link or small entry box) in order to be able to distinguish between an interaction with that object and others that are in the vicinity of the object of interest 206.

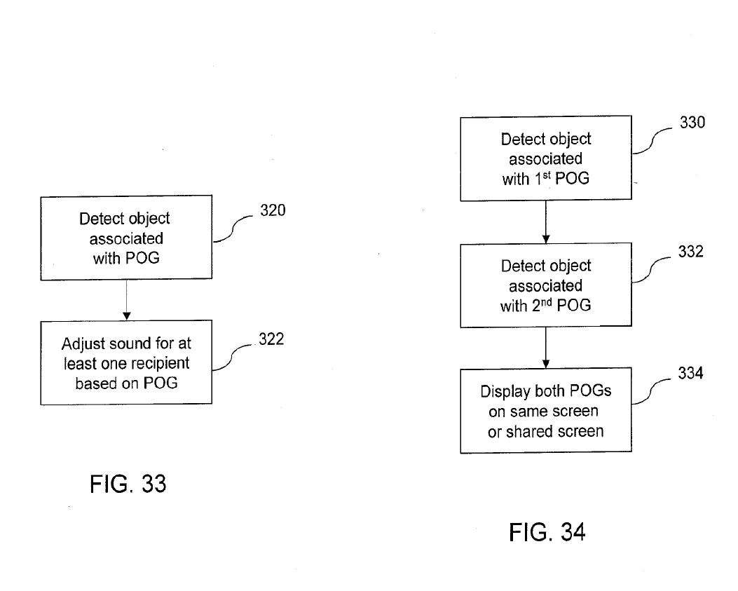

FIG. 33 illustrates an example set of operations that may be performed in adjusting sound properties in an environment 14 according to gaze information. At 320 the context module 20 determines an object associated with a detected POG 46 and adjusts sound for at least one recipient based on the POG 46 at 322. For example, as shown in FIG. 23, volume may be adjusted for multiple video conference screens 212, 214, 216, based on who the subject 12 is likely speaking to—as indicated by the POG 46.

FIG. 34 illustrates an example set of operations that may be performed in incorporating the POG 46 of two subjects 12 on the same screen. The context module 20 detects a first POG 46 at 330 and a second POG 46 at 332. Both POGs 46 are then displayed on the same screen (e.g., when two subjects 12 are looking at the same display) or on a shared screen (e.g. when two subjects 12 in different locations are looking at the same application or interface that is shared between them) at 334.

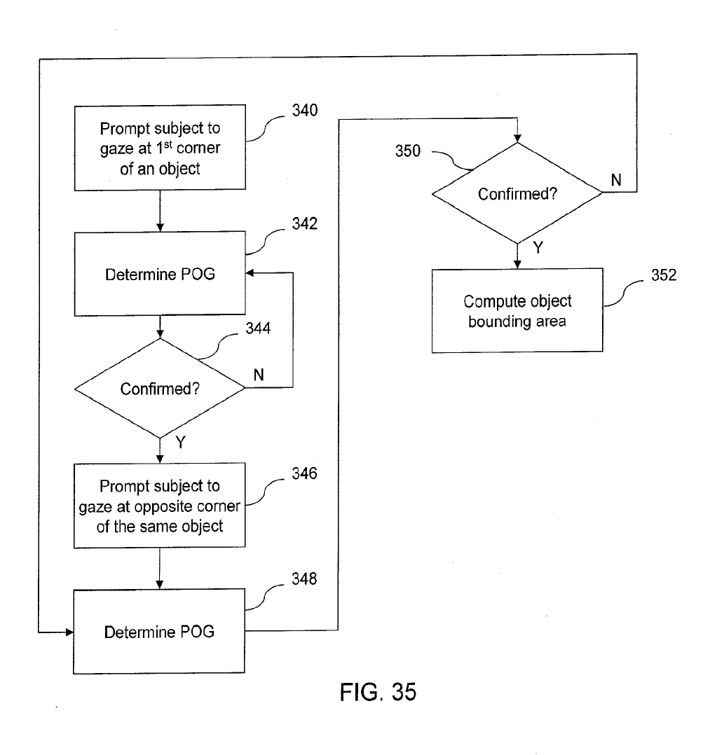

As discussed above, gaze information detected by the tracking system 10 can be used to register objects 40 in an environment 14 to enable subsequent interactions with those objects 40. For example, a subject 12 can label objects 40 in a room so that when they subsequently use a voice command, the tracking system 10 can determine which system 18 to instruct. FIG. 35 illustrates an example set of operations that may be performed in registering an object 40. In this example, the context module 20 prompts the subject to gaze at a first corner of the object 40. The context module 20 then uses the gaze tracking module 22 to determine the subject's POG 46 at 342. The context module 20 may also request that the subject 12 provide confirmation at 344 that they are gazing at a corner of the object 40. For example, the subject 12 may be instructed to provide a voice command when the subject 12 has fixed their gaze at the first corner. Once confirmed, the context module 20 then prompts the subject at 246 to gaze at the opposite corner of the same object 40 in order to define a bounding area around the 2D view of the object 40. The context module 20 then uses the gaze tracking module 22 to determine the subject's current POG 46 at 348. As with the first POG 46, the context module 20 may also request that the subject 12 provide confirmation at 350 that they are gazing at a corner of the object 40. Once confirmed, an object bounding area can be computed at 352. For 2D objects such as objects viewed on a display or 3D objects on a wall, a 2D bounding area may be sufficient. For 3D objects 40, similar principles may be applied, wherein a pair of 3D POG 46 measurements can be used to determine a bounding volume. This may be done by aligning the edges of the bounding area with a set of world coordinates.

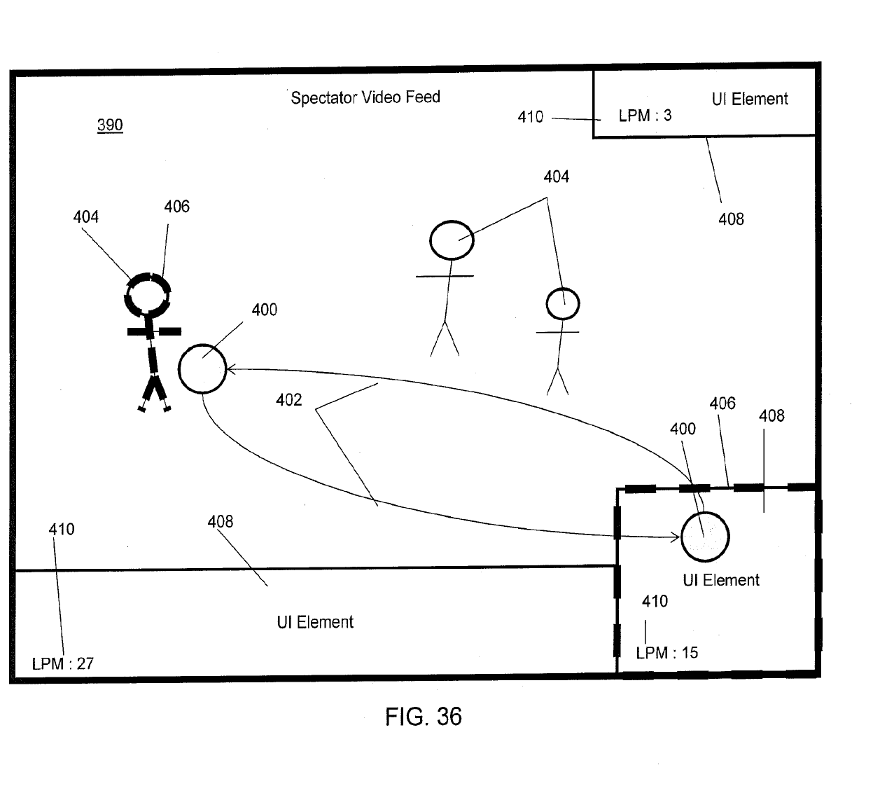

It has also been recognized that gaze information can be used to enhance interactions with electronic sports (esport) streaming feeds or video replays. For example, such streaming feeds may be used for training purposes or to assist sports commentators in explaining player's actions, similar to replay commentary tools used in major league sporting events. It may be noted that while live major sporting events occur in an arena or other sporting venues, esports players compete while looking at a display on which their gaze can be tracked, to gain insight into what the gamer is thinking. FIG. 36 illustrates a spectator video feed 390 with various example interactions that may occur in an esport environment.

The user's POG can be shown using a marker 400 to indicate the gaze position. The marker 400 may also be hidden to avoid distracting viewers. It can be appreciated that gaze information associated with the marker 400 can also be tracked in the background, e.g., for collecting statistics. Gaze trails 402 may also be shown in the video feed 390 to indicate gaze movement. The gaze trails 402 can be used to assist users in tracking where the gaze currently is, since an eye gaze can move quickly and be difficult to track. Providing gaze trails 402 can make tracking easier for the viewer.

Various other UI elements are shown in FIG. 36. For example, other players, characters or entities 404 may be shown and certain ones can be highlighted 406. The UI elements or in-game elements (e.g., 404, 408) can be highlighted to indicate gamer gaze point, rather than the gaze marker 400. Gaze highlighting 406 can be shown with changing color or intensity, by adding markers or arrows near or on the game element, by providing a particle effect, using animation such as fading in/out or moving with respect to the UI element, or any other visual effect that draws a viewer's attention to a particular UI element. Other UI elements 408 often found in games are also illustrated in FIG. 36, e.g., maps, spells, status bars, score counters and other objects in the scene or environment being viewed. Statistics can also be computed based on gaze information. For example, as shown in FIG. 36, a looks per minute (LPM) value 410 can be displayed to indicate the number of times the viewer is looking at a particular object, per period of time. Other statistics that could be displayed include, without limitation: time spent looking at an object, average look duration time, actions taken while looking at an object (e.g., killing a character while looking elsewhere), percentage of screen or game world viewed, event not viewed (e.g., a character being killed without seeing the opponent), etc.

For team games, elements looked at by more than one player could also be highlighted 406. A common visualization mode in esports occurs when the commentators show the game in spectator mode, which shows an overview of the game, but not the player's point of view. Gaze visualization methods for this mode could include: a 3D heatmap in the gaze environment; lines of sight starting from the in-game character avatar or the camera position, and intersecting with the game environment where the player is looking; changing the color/lighting/size of an in game object; adding a marker in the game world, such as a color circle on the “floor” of the game; and adding gaze markers/heatmap/notifications in a mini map or another alternate view such as proximity sensor or radar.

For training purposes, simply seeing the professional gamer's point of view would help others improve their game play by emulating the professional gamers. Professional gamers could review games and use their gaze information to better recall and describe what they were thinking at the time, similar to post-game interviews in sporting events.

It can be appreciated that training could also be done with software by, for example: analyzing the statistics mention above for a player and comparing it to those of a pro; adding in game reminders to look at specific element like maps or resources if no gaze is detected there in a long time; adding a tutorial that uses the gaze to know if the player understands/does what he is supposed to; and training people to pay attention to certain in game, e.g., by notifying the person if they do not look when they should.

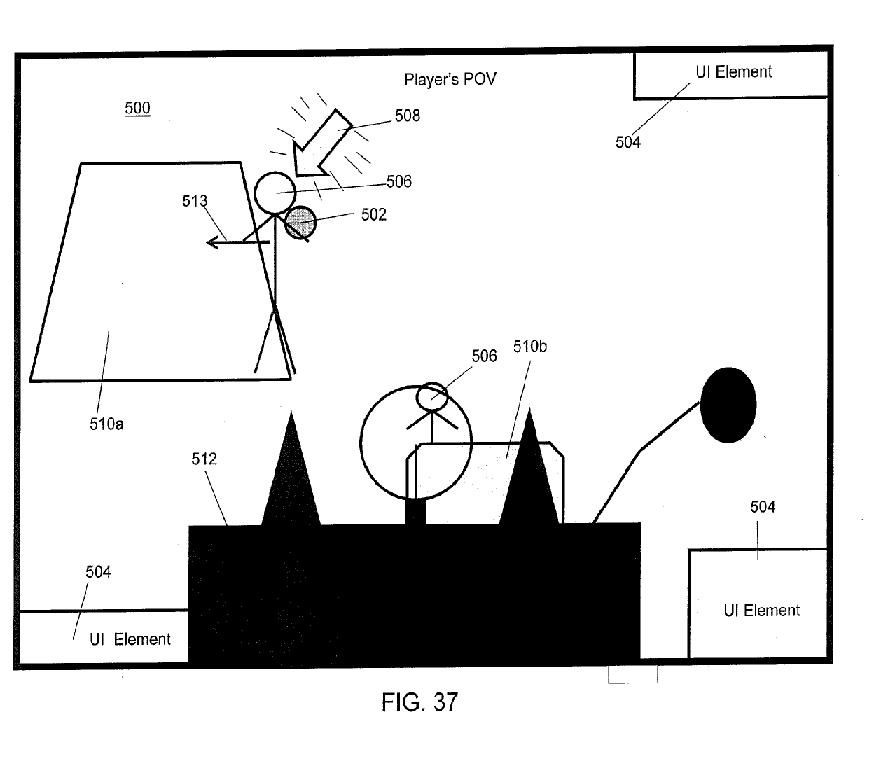

FIG. 37 illustrates various game-play mechanics that can be enhanced using gaze information. It has been recognized that current input methods for video games typically include keyboard or controller buttons, mouse or analog sticks, steering wheels, or other hand held inputs. Using gaze information enables such input mechanisms to be enhanced, enabling new interactions, for example in a player's POV screen 500. As shown in FIG. 37, a gaze marker 502 may be visible to a player, but may also be hidden to avoid distractions. As discussed above, it may be desirable to provide some feedback to the player, which could include highlighting elements in the same manner as described above. Regions of basic UI elements 504 may also be displayed, e.g., maps, spells, status bars, score counters and other objects or players that the player may be viewing. Non-player characters 506 are also shown in FIG. 37. A tagged element indicator 508 may also be used for an in-game element, e.g., to point towards a tagged object (e.g., an enemy character, teammate character, etc.) as shown in FIG. 37. Other visual in-game elements could also be tagged, for example, gaze highlights could be shown as changing color or intensity, adding markers or arrows near or on the game element, particle effect, and animations such as fading in and out or moving in some manner. In another example, anything that would take the attention of the viewer could be used to highlight features (e.g., a dot or marker on an alternative view such as a mini-map). If a tagged element is obscured by other in game elements such as a wall, the tagged element may still be seen as a using highlighting. Changing the appearance of an element may also be used to tag an element.

In game elements, e.g., obstacles 510a, 510b are also shown in FIG. 37 and can be interacted with using gaze information. An example of a weapon object 512 is also shown in FIG. 37, which is represented in a first-person shooter-type position often seen in modern video games (i.e., “iron sight” mode versus “down the hip” mode). Modern shooter-type games often use both iron sight and down the hip modes, and the player is provided with the ability to switch between these modes during game play. Each mode has different advantages and weaknesses that can be exploited or avoided during game play. Gaze information can be used during the transition from one mode to the other, such as down the hip mode to iron sight mode, which could change the target aim from the current target to the target being looked at (the gaze position).

Various game-play mechanics using gaze information and the illustrative environment shown in FIG. 37 will now be described.

Tagging in game elements is illustrated with the arrow 508 and the gaze position marker 502. Tagging an element could be done with the gaze alone, e.g. by lingering at an element for long enough. This lingering action once past a predefined threshold would make the element tagged. Tagging could also be done at a press of a button, which would instantly tag whatever is being looked at. If the gaze is near the target but not directly on the target, the tagging could be algorithmically aided so that the gaze targets the nearest object and does not need to be directly on or within the object, and/or the button press does not need to be exactly at the moment of the “look”.

Another game mechanic relates to non-character players 506. Artificial intelligence is becoming more prevalent and important in modern gaming, and having non-player characters 506 behaving realistically is desirable. Providing realistic behavior for such characters 506 often demands significant processing power and a balance should be found between the graphics provided, and the artificial intelligence provided. Using gaze information, behaviors of non-player characters 506 can be modified. For example, non playing characters 506 can be made to take cover when they are “looked at” as illustrated in FIG. 37 with the arrow 513 and the gaze cursor 502 representing the action of the character 506. The non player character 506 could also change behavior if the player looks at it, for example, the non player character 506 could begin speaking to the player, or could become nervous and eventually flee. Non player characters 506 could also wait until the player ceases to look in its direction before changing “cover position”. The non player character 506 could also appear where the player is, or is not, looking, in order to surprise the player with the desired effect associated with surprise.

It has also been found that gaze information could also be used to assist the player in aiming a weapon, sporting equipment or other implement. For example, at the push of a button, the aim could switch from its current position (e.g., the middle of the screen) to the position the player is looking at (or alternatively the camera world view centered on the screen). Since the gaze is not the main aiming input but only used sporadically using gaze as an input should not tire the player. Moreover, the aim could immediately go back to the previous control method (e.g., mouse or joystick) such that the user can correct for any inaccuracy in the gaze. This could be done while switching from hip mode to iron sight mode discussed above. For example, when changing to iron sight mode, the aiming could change from the target (506) to where the player is looking (502).

Tracking a player's gaze could also enable a new “concentration” mechanism in many game types. For example, at any point, if a player's gaze remains on the same object for a certain period of time, different attributes could change. Chances of success for an action could increase if the player stares at the target for a period of time before doing the action, aiming that simulates breathing could become steadier when the player fixes the target, etc.

Another game mechanism could be used in a tutorial or to guide the player in the right direction. Often in games, the player can encounter puzzles or need to take a certain path. Sometimes, it is not apparent what the player can interact with or where he/she needs to go. One way to help the player would be to draw the player's attention to a particular element by highlighting it when it is in the peripheral vision of the player. The hint would be removed before the player can see it in is fovea. In this way, the hint system would not give the answer but get the player's attention in the right direction. The hint itself would be similar to those described previously, for example: gaze highlights could be shown as changing color or intensity, adding markers or arrows near or on the game element, particle effect, animations such as fading in and out or moving in some manner, any other effect that would grab the attention of the player, etc. It can be appreciated that an in game tutorial could also benefit from the gaze information, since it would be possible to know if the player looked at an information pop-up or if they saw the game feature being referred to by the tutorial.

A player's gaze could also be used to control the POV and an aiming mechanism independently. For example, the POV could be controlled with a mouse and the aim directed were the gaze is on the screen. This could be a default behavior or could be activated at the press of a button. The contrary would also be possible by enabling aim to be controlled with the mouse and the gaze information used to influence the POV. For example, the POV can be caused to change at the press of a button or if the gaze is far enough from the center of the screen, the POV could change so that the player can get a better look at what interests him/her there. This could be apply in many type of games, for example, a driving game where looking at the mirror could bring the mirror view closer. If the player fixes their gaze on something in particular, the view could zoom in to the associated object.

It has also been found that in online games, a problem that often arises is the use of bots or computer scripts to cheat the game mechanics. For example, a script may automate an in game action such as gathering resources to increase a players score automatically without the player having to manually perform the actions. The gaze information could be used to differentiate between a real player (looking at the screen) and a script or bot which would have difficulty emulating the natural human visual system movements. The gaze information could be sent to the server and if it is not compatible with normal human behavior a number of measures could be taken, for example one of the game authorities could be contacted.

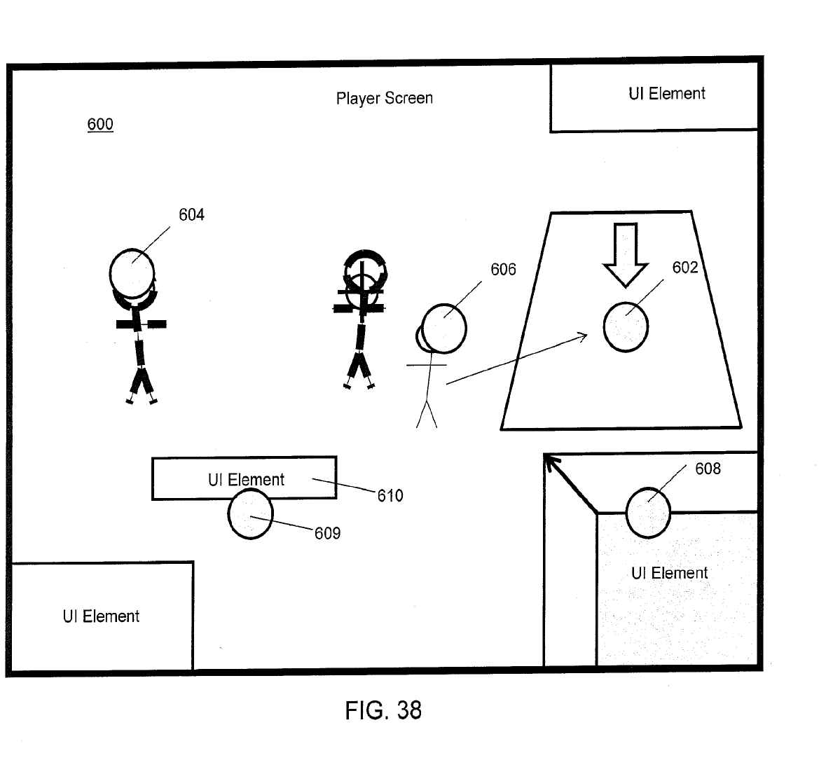

Turning now to FIG. 38, various ways of interacting with in-game content on a player screen 600, using the gaze information from a player, is shown. Unlike other types of game play, where actions are tied to a specific key used when a mouse or other input mechanism is pointed at a specific object, the gaze of a player provides information that can modify the behavior of various keys depending on where the player is looking. Various examples are shown in FIG. 38, which will now be described. At 602, a player's POG may be used when looking at a static object to, for example, issue orders without moving a mouse or joystick (e.g, to instruct an ally to hide from an enemy using a key press and the gaze position, while targeting the enemy). Also, POG on a static object allows a player's view to be focused in or zoomed on what he/she is looking at instead of other surrounding events.

At 604, the POG of the player is pointed at another character, e.g., an enemy. This scenario allows for the outcome of certain actions to be altered by the gaze information. For example, in a game where aiming is required, a punch could be aimed at the area that is being looked at instead of in a general direction. For games that are gesture enabled, a gesture could be aimed toward the area someone is looking to increase precision. Moreover, when looking at an enemy for a particular period of time, certain information such as health, name or action warnings could be displayed only for the character that is being looked at. This information could also be displayed for allies.

At 606, the POG of the player is pointed at an ally. When looking at an ally and pressing a specific key, the outcome could be different than when looking at an enemy. For example, a key press that injures an enemy could be used to give aid to an ally. In team games, gaze could be used to determine which ally you are targeting for a positive action, like throwing a ball. When two players look at each other's in-game avatar, interaction specific options can be enabled, such as player trades, private chats, etc.

At 608, the POG of the player is pointed at a UI element. When looking at a particular element, the element can be resized (e.g., made bigger for ease of reading). Also, when looking at a semi-transparent UI element, the transparency can be decreased. This allows for an easy to read UI when looked at and an unobstructed peripheral vision when the UI element is not being looked at. A UI element 610 could also be shown near or at the gaze position 609 at the press of a button. This would allow the player to see information while still looking at a target. The UI element 610 could appear and stay in place while the button is pressed or appear and follow the gaze 609 while the button is pressed.

Various 2D applications could also be implemented, such as a character facing the way the player is looking. Also, in-game elements could be used to increase the precision of the game. For example, a player looking at another character, but not exactly on him, could still be able to get his gaze properly analyzed by using the surrounding elements of the game to identify what is of interest in the region that is being looked at. An algorithm could also be deployed to analyze the region being looked at and influence the outcome of certain actions. An action that occurs on an area could be triggered near the point where the player is looking at, but corrected to be in the most efficient place, e.g., centered amongst enemies.

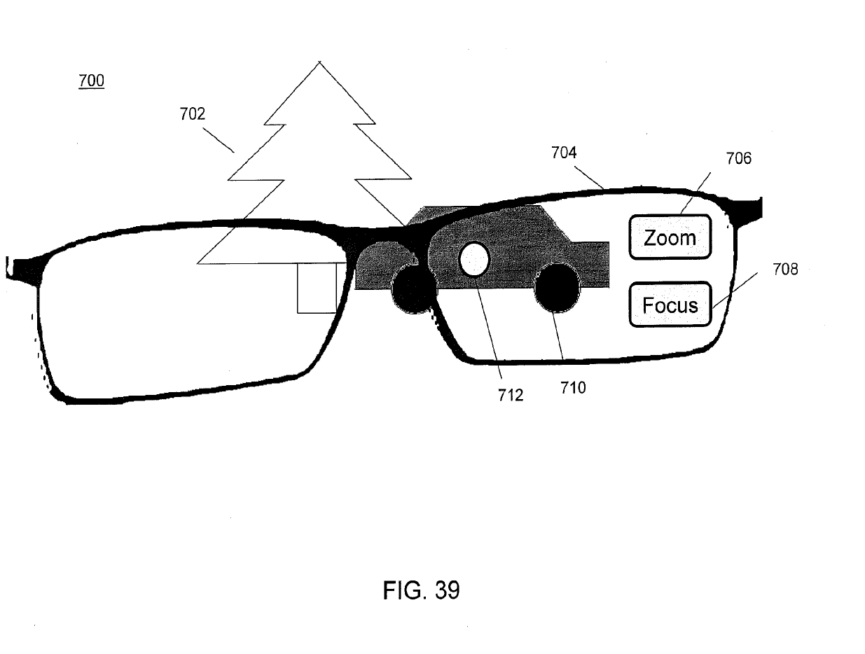

In FIG. 39, the use of gaze information to enhance interaction in an environment 700 in which a heads up interface 704 is used, is shown. Such a heads up interface 704 may include, without limitation, a display, camera, voice recognition system, gesture recognition system, media player, etc.

Gaze tracking functionality may be integrated within various heads up interfaces 704 such as the eye-glasses shown in FIG. 39, as well as for in-ear Bluetooth headsets, contact lenses, or other means by which gaze information can be tracked from the eyes. A scene 702 being observed by a user may be a real world scene or a 2D or 3D display. The scene 702 may be tracked through an integrated camera in the heads up interface 704, or alternatively identifiers of real-world scene objects can provide reference points, such as the GPS coordinates of a billboard along a highway. The point of gaze 712 or region in the scene 702 that is being viewed by the user can be determined, either through mapping the point of gaze 712 on the image of the scene 702 (captured by an integrated camera), or using the intersection of the viewer's line of sight with real-world objects, as determined by the position and orientation of the viewer's head and eye direction and intersection with real world objects.

Interaction can be undertaken by the viewer through the heads up interface 704 by looking at a scene element 710 or by looking at heads up display interaction elements for example a zoom button 706 or a focus button 708 shown in FIG. 39. Dwell selecting, i.e., gazing for a short period of time on the object or control of interest can be used to make a selection. Alternatively, multimodal interaction such as voice commands and gestures can be used to make a selection. For example, when in a camera mode and viewing the scene element 710, the integrated camera may focus on the element 710 being viewed (i.e. the car and not the tree in FIG. 39), and a glance at a shutter “button”, or by speaking ‘click’ would result in capturing an image.

In addition to the camera mode described above, numerous other modes of operation are possible. For example a media player mode can also be provided. When in media player mode, the interaction elements may display the current playing music track, or the current playlist which the viewer can gaze up or down to scroll and then dwell on a different track to play a different song.

An augmented reality mode could provide information in which information is overlaid on the scene content viewed, for example when looking at the car, the make and model and a link to the manufacturers website may be provided.

A social media mode can also be provided, wherein if the user is looking at a person (as identified by the point of gaze 712), the person can be identified by face recognition or by another identifier (such as their phone GPS coordinate), and their latest online profile updates shown in the heads up display 704. In yet another example, an image of an object being viewed can be captured, cropped, stylized through pre-programmed image filters and uploaded to a social network page.

It will be appreciated that the example embodiments and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above principles have been described with reference to certain specific example embodiments, various modifications thereof will be apparent to those skilled in the art as outlined in the appended claims.

1. A method of enhancing inputs or interactions, the method comprising:
correlating gaze information for a subject to information corresponding to an environment; and
providing an enhancement to an input or interaction between the subject and the environment.

2. The method of claim 1, wherein the information corresponding to the environment comprises a location of an object or system in the environment.

3. The method of claim 2, wherein the correlating comprises comparing a point of gaze (POG) or line of sight (LOS) intersection of the subject to the location of the object or system in the environment.

4. The method of claim 3, wherein the enhancement comprises detecting the input or interaction from the subject and applying the input or interaction to the environment according to the POG of the subject.

5. The method of claim 1, wherein the gaze information is obtained using a gaze tracking module.

6. The method of claim 1, wherein the information corresponding to the environment is obtained from metadata provided by a system, device, or entity associated with the environment.

7. The method of claim 3, wherein the input or interaction from the subject is detected using an input/interaction tracking module.

8. The method of claim 7, wherein the input/interaction tracking module is operable to obtain any one or more of an image, a video, sound, motion, and a physical interaction, from the subject.

9. The method of claim 1, wherein the enhancement comprises using the gaze information to apply a gesture to an object of interest.

10. The method of claim 9, wherein the enhancement comprises distinguishing between multiple possible objects of interest according to the gaze information.

11. The method of claim 1, wherein the enhancement comprises using the gaze information to apply a voice command to an object of interest.

12. The method of claim 9, wherein the object of interest is provided in a user interface (UI) displayed on a computer screen.

13. The method of claim 12, wherein the UI comprises any one or more of a button, a drop down selection mechanism, a scroll bar, a slider, a combo-box, a tree control, a text box, and a checkbox.

14. The method of claim 1, wherein the enhancement comprises using a first point of gaze (POG) to enable interaction with a first interface object and detection of a second POG to enable interaction with a second interface object.

15. The method of claim 14, wherein the first and second interface objects are text entry boxes.

16. The method of claim 14, wherein the first and second interface objects are application windows.

17. The method of claim 1, wherein the enhancement comprises using the gaze information to predict and perform an action on an object of interest.

18. The method of claim 1, wherein the enhancement comprises providing an input element on a touchscreen that is remote from an object of interest associated with the gaze information.

19. The method of claim 18, wherein the input element is a soft key displayed away from the object of interest.

20. The method of claim 1, wherein the enhancement comprises using the gaze information to target an object of interest on a touchscreen to enable another input to select the object of interest.

21. The method of claim 20, wherein the other input comprises any one or more of a fixation of a POG on the object of interest for a predetermined amount of time, a voice command, and a gesture.

22. The method of claim 1, wherein the enhancement comprises adjusting a sound property for at least one recipient in the environment.

23. The method of claim 22, wherein the sound property comprises a volume of the subject to be directed to the plurality of recipients.

24. The method of claim 23, wherein a plurality of recipients are communicable with the subject via a network connection.

25. The method of claim 1, wherein the enhancement comprises displaying a plurality of visual elements, each visual element associated with a different subject.

26. The method of claim 25, wherein the plurality of visual elements comprise indicators for respective points of gaze (POGs) for the corresponding subjects.

27. The method of claim 22, wherein at least two subjects are in different locations.

28. The method of claim 1, wherein the environment comprises any one or more of real-world, augmented real-world, virtual world, a two dimensional (2D) display, and a three dimensional (3D) display.

29. The method of claim 1, wherein the environment comprises an electronic sports video feed.

30. The method of claim 1, wherein the environment comprises game play.

31. The method of claim 1, wherein the environment is being viewed using a heads up interface.

32. A method of enabling enhanced inputs or interactions with objects in an environment, the method comprising:
correlating gaze information for a subject to a registration input corresponding to an object in the environment; and
registering a position of the object in the environment using the gaze information.

33. The method of claim 32, further comprising obtaining an identifier for the object and associating the identifier with the object for subsequent interactions with the object.

34. The method of claim 32, wherein the gaze information comprises a plurality of points of gaze (POG) of the subject and the registering comprises defining a bounding area or volume surrounding the object according to the plurality of POGs.

35. The method of claim 32, further comprising obtaining a timestamp for a current location of the object in the environment, and updating an object position over time using new current locations to repeatedly determine a positioning of the object in the environment.

36. The method of claim 32, further comprising obtaining a range of available actions for the object in the environment, to enable subsequent interactions with the object in the environment.

37. A computer readable storage medium comprising computer executable instructions for performing the method of claim 1.

38. An electronic device comprising a processor and memory, the memory comprising computer executable instructions for causing the processor to perform the method of claim 1.

39. A tracking system comprising the electronic device of claim 38.
